(19) United States
(12) Patent Application Publication
(10) Pub. No.: US 2012/0163541 A1
(43) Pub. Date: Jun. 28, 2012

(54) RADIOGRAPHIC APPARATUS AND RADIATION IMAGE DETECTOR

(75) Inventor: Yasuhisa KANEKO, Ashigarakami-gun (JP)

(73) Assignee: FUJIFILM CORPORATION, Tokyo (JP)

(21) Appl. No.: 13/337,367

(22) Filed: Dec. 27, 2011

(30) Foreign Application Priority Data
Dec. 24, 2010 (JP) 2010-288218
Dec. 21, 2011 (JP) 2011-279327

(51) Int. Cl. G01T 1/24; G01N 23/20

(52) U.S. Cl. 378/70; 250/370.09

(57) ABSTRACT

In a radiographic apparatus for obtaining a phase contrast image, and which includes a first grating and a second grating arranged with a predetermined distance therebetween, one of the first grating and the second grating is composed of plural unit gratings, each corresponding to a pixel, arranged in the direction of pixel columns. Further, the plural unit gratings are arranged in such a manner to be shifted, parallel to each other, in a direction orthogonal to a direction in which the other one of the first grating and the second grating extends by distances different from each other with respect to the other one of the first grating and the second grating. Further, image signals read out from groups of pixel rows, the groups being different from each other, are obtained, as image signals representing fringe images different from each other, based on image signals obtained by the radiation image detector by detecting radiation that has passed through the first grating and the second grating. Further, a phase contrast image is generated based on the image signals representing the plural of fringe images.

### BACKGROUND OF THE INVENTION

1. Field of the Invention

The present invention relates to a radiographic apparatus utilizing gratings, and a radiation image detector used in the radiographic apparatus.

2. Description of the Related Art

Since X-rays attenuate depending on the atomic number of an element constituting a substance through which the X-rays pass, and the density and the thickness of the substance, the X-rays are used as a probe for observing the inside of a subject from the outside of the subject. Radiography using X-rays is widely used in medical diagnosis, non-destructive examination, and the like.

In a general X-ray radiography system, a subject is placed between an X-ray source for outputting X-rays and an X-ray image detector for detecting an X-ray image. In this state, radiography is performed on the subject to obtain a transmission image of the subject. In this case, each of X-rays output from the X-ray source toward the X-ray image detector attenuates (is absorbed) by an amount based on a difference in the properties (atomic number, density, and thickness) of a substance or substances constituting the subject that is present in a path to the X-ray image detector, and the attenuated X-rays enter the X-ray image detector. Consequently, an X-ray transmission image of the subject is detected by the X-ray image detector, and an image is formed. As the X-ray image detector, a combination of an X-ray sensitizing screen and a film, or a photostimulable phosphor is used. Further, a flat panel detector (FPD) using a semiconductor circuit is widely used.

However, the X-ray absorptivity of a substance is lower as the atomic number of an element constituting the substance is smaller. Since a difference in X-ray absorptivity is small in soft tissue of a living body, soft material, and the like, a sufficient difference in intensity (contrast) as an X-ray transmission image is not obtainable. For example, both of cartilage constituting a joint in a human body and synovial fluid around the joint are mostly composed of water. Therefore, a difference in X-ray absorptivity between the two is small, and a sufficient contrast in an image is hard to obtain.

In recent years, X-ray phase imaging has been studied. In X-ray phase imaging, a phase contrast image based on a shift in the phase of X-rays caused by a difference in the refractive index of a subject to be examined is obtained, instead of an image based on a change in the intensity of X-rays caused by a difference in the absorption coefficient of the subject to be examined. In the X-ray phase imaging using the phase difference, high contrast images are obtainable even if the subject is a low absorption object, which has low X-ray absorptivity.

As such X-ray phase imaging, for example, in PCT International Publication No. WO2008/102654 (Patent Document 1) and Japanese Unexamined Patent Publication No. 2010-190777, radiation phase image radiographic apparatuses have been proposed. In the radiation phase image radiographic apparatus, two gratings, namely, a first grating and a second grating are arranged parallel to each other with a predetermined distance therebetween. Further, a self image of the first grating is formed at the position of the second grating by a Talbot interference effect by the first grating. Further, the second grating modulates the intensity of the self image to obtain a radiation phase contrast image.

In the radiation phase image radiographic apparatuses disclosed in Patent Document 1 and Patent Document 2, the second grating is arranged substantially parallel to a plane on which the first grating is provided. While the first grating or the second grating is translationally moved, relative to each other, in a direction substantially orthogonal to the direction of the grating, one by one, by a predetermined pitch narrower than the grating pitch of the grating, radiography is performed at each translational movement to obtain plural images. Further, a phase change amount (differential phase shift value) of X-rays induced by an interaction with the subject to be examined is obtained based on the obtained plural images by using a fringe scan method. Further, a phase contrast image of the subject to be examined is obtainable based on the differential phase shift value.

However, in the radiation phase image radiographic apparatuses disclosed in Patent Document 1 and Patent Document 2, it is necessary to accurately move the first grating or the second grating at a pitch narrower than the grating pitch of the grating, as described above. The grating pitch is typically a few μm, and an even higher accuracy is required in the pitch of the translational movement of the grating. Therefore, an extremely highly accurate movement mechanism is needed, and consequently, the mechanism becomes complex, and the cost of the apparatus becomes high. Further, when radiography is performed at each movement of the grating, a positional relationship between the subject to be examined and a radiography system changes between operations in a series of radiography operations for obtaining the phase contrast image, because of the movement of the subject to be examined, a vibration of the apparatus, or the like. Therefore, it is impossible to correctly obtain a phase change of X-rays induced by an interaction with the subject to be examined. Consequently, an excellent phase contrast image is not obtainable.

### SUMMARY OF THE INVENTION

In view of the foregoing circumstances, it is an object of the present invention to provide a radiographic apparatus that can obtain an excellent phase contrast image by performing one radiography operation without using a highly accurate movement mechanism. Further, it is another object of the present invention to provide a radiation image detector used in the radiographic apparatus.

A radiographic apparatus of the present invention is a radiographic apparatus comprising:

a first grating in which a grating structure is periodically arranged, and that forms a first periodic pattern image by passing radiation output from a radiation source;

a second grating in which a grating structure is periodically arranged, and that forms a second periodic pattern image by receiving the first periodic pattern image; and

a radiation image detector in which pixels that detect the second periodic pattern image formed by the second grating are two-dimensionally arranged, and pixel rows of which are sequentially scanned with respect to the direction of pixel columns orthogonal to the pixel rows so as to sequentially read out image signals corresponding to the second periodic pattern image for each of the pixel rows,

wherein one of the first grating and the second grating is composed of a plurality of unit gratings, each corresponding to each pixel arranged in the direction of pixel columns, and which are arranged in the direction of pixel columns, and

wherein the plurality of unit gratings are arranged in such a manner to be shifted, parallel to each other, in a direction orthogonal to a direction in which the other one of the first grating and the second grating extends by distances different from each other with respect to the other one of the first grating and the second grating, and

the apparatus further comprising:

an image generation unit that obtains, based on the image signals obtained by the radiation image detector, image signals read out from groups of the pixel rows, the groups being different from each other, as image signals representing a plurality of fringe images different from each other, and that generates a radiographic image based on the obtained image signals representing the plurality of fringe images.

In the radiographic apparatus of the present invention, the unit grating may be rectangular.

Further, the unit gratings adjacent to each other may form a level difference (step) therebetween.

Further, the second grating may be arranged at a position away from the first grating by a Talbot interference distance, and modulate the intensity of the first periodic pattern image formed by a Talbot interference effect of the first grating.

The first grating may be an absorption-type grating that forms the first periodic pattern image by passing the radiation as a projection image, and the second grating may modulate the intensity of the first periodic pattern image as the projection image that has passed through the first grating.

The second grating may be arranged at a distance shorter than a minimum Talbot interference distance from the first grating.

Further, images of the plurality of unit gratings may be arranged in such a manner to be shifted parallel to each other, one by one, by P/M with respect to the other one of the first grating and the second grating, where P is a pitch of the other one of the first grating and the second grating, and M is the number of the fringe images.

A radiographic apparatus of the present invention is a radiographic apparatus comprising:

a grating in which a grating structure is periodically arranged, and that forms a periodic pattern image by passing radiation output from a radiation source; and

a radiation image detector including a first electrode layer that passes the periodic pattern image formed by the grating, a photoconductive layer that generates charges by irradiation with the periodic pattern image that has passed through the first electrode layer, a charge storage layer that stores the charges generated in the photoconductive layer, and a second electrode layer in which a multiplicity of linear electrodes that pass readout light are arranged, which are deposited one on another in this order, and from which an image signal for each pixel corresponding to each of the linear electrodes is readout by being scanned with the readout light, and

wherein a plurality of unit grating patterns, each corresponding to each pixel arranged in a direction in which the linear electrodes extend, are arranged in the direction in which the linear electrodes extend in the charge storage layer, and

wherein the plurality of unit grating patterns are arranged in such a manner to be shifted, parallel to each other, in a direction orthogonal to a direction in which the grating extends by distances different from each other with respect to the grating, and

the apparatus further comprising:

an image generation unit that regards, as a direction of pixel rows, a direction in which the linear electrodes are arranged, and regards, as a direction of pixel columns, a direction in which the linear electrodes extend, and obtains, based on image signals obtained by the radiation image detector, image signals read out from groups of the pixel rows, the groups being different from each other, as image signals representing a plurality of fringe images different from each other, and that generates a radiographic image based on the obtained image signals representing the plurality of fringe images.

In the radiographic apparatus of the present invention, the unit grating pattern may be rectangular.

The unit grating patterns adjacent to each other may form a level difference therebetween.

Further, the plurality of unit grating patterns may be arranged in such a manner to be shifted parallel to each other, one by one, by P/M with respect to an image of the grating, where P is a pitch of the image of the grating, and M is the number of the fringe images.

A radiographic apparatus of the present invention is a radiographic apparatus comprising:

a grating in which a grating structure is periodically arranged, and that forms a periodic pattern image by passing radiation output from a radiation source; and

a radiation image detector including a first electrode layer that passes the periodic pattern image formed by the grating, a photoconductive layer that generates charges by irradiation with the periodic pattern image that has passed through the first electrode layer, a charge storage layer that stores the charges generated in the photoconductive layer, and a second electrode layer in which a multiplicity of linear electrodes that pass readout light are arranged, which are deposited one on another in this order, and from which an image signal for each pixel corresponding to each of the linear electrodes is readout by being scanned with the readout light, and

wherein the charge storage layer is grid-shaped at a pitch narrower than an arrangement pitch of the linear electrodes, and

wherein a plurality of unit gratings, each corresponding to each pixel arranged in a direction in which the linear electrodes extend, are arranged in the direction in which the linear electrodes extend, and

wherein the plurality of unit gratings are arranged in such a manner to be shifted, parallel to each other, in a direction orthogonal to a direction in which the charge storage layer extends by distances different from each other with respect to a grating pattern of the charge storage layer, and

the apparatus further comprising:

an image generation unit that regards, as a direction of pixel rows, a direction in which the linear electrodes are arranged, and regards, as a direction of pixel columns, a direction in which the linear electrodes extend, and obtains, based on image signals obtained by the radiation image detector, image signals read out from groups of the pixel rows, the groups being different from each other, as image signals representing a plurality of fringe images different from each other, and that generates a radiographic image based on the obtained image signals representing the plurality of fringe images.

In the radiographic apparatus of the present invention, the unit grating may be rectangular.

Further, the unit gratings adjacent to each other may form a level difference therebetween.

Further, images of the plurality of unit gratings may be arranged in such a manner to be shifted parallel to each other, one by one, by P/M with respect to the grating pattern of the charge storage layer, where P is a pitch of the grating pattern of the charge storage layer, and M is the number of the fringe images.

Further, the grating may be a phase-modulation-type grating that modulates phase by 90° or an amplitude-modulation-type grating, and pitch P₁′ of the periodic pattern image at the position of the radiation image detector, and arrangement pitch P₂ of a grating structure in the charge storage layer may satisfy the following formula:

$${P}_{2} = {P}_{1}^{′} = \frac{{Z}_{1} + {Z}_{2}}{{Z}_{1}} {P}_{1} ,$$

where P₁ is a grating pitch of the grating, and Z₁ is a distance from a focal point of the radiation source to the grating, and Z₂ is a distance from the grating to a detection surface of the radiation image detector.

Alternatively, the grating may be a phase-modulation-type grating that modulates phase by 180°, and pitch P₁′ of the periodic pattern image at the position of the radiation image detector, and arrangement pitch P₂ of a grating structure in the charge storage layer may satisfy the following formula:

$${P}_{2} = {P}_{1}^{′} = \frac{{Z}_{1} + {Z}_{2}}{{Z}_{1 }} \cdot \frac{{P}_{1}}{2} ,$$

where P₁ is a grating pitch of the grating, and Z₁ is a distance from a focal point of the radiation source to the grating, and Z₂ is a distance from the grating to a detection surface of the radiation image detector.

The radiographic apparatus may further include a multi-slit composed of an absorption-type grating in which a plurality of radiation blocking members that block the radiation extend at a predetermined pitch, and which is arranged between the radiation source and the grating to selectively block an area of the radiation output from the radiation source. Further, predetermined pitch P₃ of the multi-slit may satisfy the following formula:

$${P}_{3} = \frac{{Z}_{3}}{{Z}_{2 }} {P}_{1}^{′} ,$$

where Z₃ is a distance from the multi-slit to the grating, and Z₂ is a distance from the grating to a detection surface of the radiation image detector, and P₂ is an arrangement pitch of a grating structure in the charge storage layer, and P₁′ is a pitch of the periodic pattern image at the position of the radiation image detector.

Further, the thickness of the charge storage layer in a direction in which the first electrode layer, the photoconductive layer, the charge storage layer and the second electrode layer are deposited one on another may be less than or equal to 2 μm.

The dielectric constant of the charge storage layer may be less than or equal to twice and greater than or equal to ½ of the dielectric constant of the photoconductive layer.

The radiation image detector may be arranged at a position away from the grating by a Talbot interference distance, and modulate the intensity of the periodic pattern image formed by a Talbot interference effect of the grating.

The grating may be an absorption-type grating that forms the periodic pattern image by passing the radiation as a projection image, and the radiation image detector may modulate the intensity of the periodic pattern image as the projection image that has passed through the grating.

The radiation image detector may be arranged at a distance shorter than a minimum Talbot interference distance from the grating.

Further, a linear readout light source that extends in a direction in which the pixel rows extend may be provided, and the radiation image detector may be scanned by the linear readout light source in a direction in which the pixel columns extend so as to read out the image signals.

The image generation unit may obtain, as image signals representing fringe images different from each other, image signals read out from the pixel rows next to each other.

The image generation unit may obtain, as image signals representing a fringe image, image signals read out from a group of pixel rows arranged at an interval of at least two pixels therebetween, and obtain, as image signals representing fringe images different from each other, image signals readout from groups of the pixel rows, the groups being different from each other.

The image generation unit may generate, based on the image signals representing the plurality of fringe images, at least one of a phase contrast image, a small-angle scattering image, and an absorption image.

A radiation image detector of the present invention is a radiation image detector comprising:

a first electrode layer that passes radiation;

a photoconductive layer that generates charges by irradiation with the radiation that has passed through the first electrode layer;

a charge storage layer that stores the charges generated in the photoconductive layer; and

a second electrode layer in which a multiplicity of linear electrodes that pass readout light are arranged, which are deposited one on another in this order, and from which an image signal for each pixel corresponding to each of the linear electrodes is read out by being scanned with the readout light,

wherein a plurality of unit grating patterns, each corresponding to each pixel arranged in a direction in which the linear electrodes extend, are arranged in the direction in which the linear electrodes extend in the charge storage layer, and

wherein the plurality of unit grating patterns are arranged in such a manner to be shifted, parallel to each other, in a direction orthogonal to the direction in which the linear electrodes extend by distances different from each other with respect to the linear electrodes.

According to the radiographic apparatus of the present invention, one of the first grating and the second grating is composed of a plurality of unit grating arranged in the direction of pixel columns, and the plurality of unit gratings are arranged in such a manner to be shifted, parallel to each other, in a direction orthogonal to a direction in which the other one of the first grating and the second grating extends by distances different from each other with respect to the other one of the first grating and the second grating. Further, image signals read out from groups of pixel rows, the groups being different from each other, are obtained, based on image signals obtained by a radiation image detector by detecting radiation that has passed through the first grating and the second grating, as image signals representing a plurality of fringe images different from each other. Further, a phase contrast image is generated based on the obtained image signals representing the plurality of fringe images. Therefore, unlike conventional apparatuses, it is not necessary to use a highly accurate movement mechanism for moving the second grating. Further, it is possible to obtain a plurality of fringe images for obtaining a phase contrast image by performing one radiography operation.

Alternatively, the charge storage layer of the radiation image detector may be formed in grid shape to provide a function of the second grating in the radiation image detector. When the charge storage layer is formed in such a manner, it is not necessary to provide a grating that needs to be formed at a high aspect ratio, and which is difficult to be produced. Hence, production of the apparatus becomes even easier.

Further, in the grid-shaped charge storage layer of the radiation image detector, a plurality of unit grating patterns may be arranged in the direction in which the linear electrodes extend, and the plurality of unit grating patterns may be shifted, parallel to each other, in a direction orthogonal to a direction in which the grating extends by distances different from each other with respect to the grating in a manner similar to the aforementioned grating. When the charge storage layer is formed in such a manner, it is possible to produce the unit grating patterns more easily than the aforementioned grating.

### BRIEF DESCRIPTION OF THE DRAWINGS

FIG. 1 is a schematic diagram illustrating the structure of a first embodiment of a radiation phase image radiographic apparatus according to the present invention;

FIG. 2 is a top view of the radiation phase image radiographic apparatus illustrated in FIG. 1;

FIG. 3 is a schematic diagram illustrating the structure of a first grating;

FIG. 4 is a partial cross section of the first grating;

FIG. 5 is a schematic diagram illustrating the structure of a second grating;

FIG. 6 is a partial cross section of the second grating;

FIG. 7A is a schematic diagram illustrating the structure of an optical-readout-type radiation image detector;

FIG. 7B is a schematic diagram illustrating the structure of the optical-readout-type radiation image detector;

FIG. 7C is a schematic diagram illustrating the structure of the optical-readout-type radiation image detector;

FIG. 8 is a diagram illustrating relationships among pixel size Dx in X direction of a radiation image detector, pixel size Dy in Y direction of the radiation image detector, self image G1 of a first grating formed by radiation that has passed through the first grating, and a grid member of a second grating;

FIG. 9A is a diagram for describing an action of recording by the radiation image detector illustrated in FIGS. 7A through 7C;

FIG. 9B is a diagram for describing the action of recording by the radiation image detector illustrated in FIGS. 7A through 7C;

FIG. 10 is a diagram for describing an action of reading out by the radiation image detector illustrated in FIGS. 7A through 7C;

FIG. 11 is a diagram for describing an action of obtaining plural fringe images based on image signals read out from an optical-readout-type radiation image detector;

FIG. 12 is a diagram for describing an action of obtaining plural fringe images based on image signals read out from the optical-readout-type radiation image detector;

FIG. 13 is a diagram illustrating an example of a path of radiation refracted based on phase shift distribution Φ(x) with respect to X direction of a subject to be examined;

FIG. 14 is a diagram for describing a method for generating a phase contrast image;

FIG. 15 is a diagram illustrating a comparative example for explaining an effect of the radiographic apparatus of the present invention;

FIG. 16 is a diagram illustrating an arrangement relationship between a radiation image detector using TFT switches and first and second gratings;

FIG. 17 is a schematic diagram illustrating the structure of a radiation image detector using a CMOS sensor;

FIG. 18 is a diagram illustrating the structure of a pixel circuit of the radiation image detector using the CMOS sensor;

FIG. 19 is a diagram illustrating an arrangement relationship between the radiation image detector using the CMOS sensor and first and second gratings;

FIG. 20 is a diagram illustrating another example of arrangement of self images of unit grating members of a first grating;

FIG. 21 is a diagram for describing methods for generating an absorption image and a small-angle scattering image;

FIG. 22A is a diagram for describing a structure in which a first grating and a second grating are rotated by 90°;

FIG. 22B is a diagram for describing the structure in which the first grating and the second grating are rotated by 90°;

FIG. 23A is a schematic diagram illustrating the structure of an embodiment of a radiation image detector used in the radiographic apparatus of the present invention;

FIG. 23B is a schematic diagram illustrating the structure of the embodiment of the radiation image detector used in the radiographic apparatus of the present invention;

FIG. 23C is a schematic diagram illustrating the structure of the embodiment of the radiation image detector used in the radiographic apparatus of the present invention;

FIG. 24A is a diagram for describing an action of recording by the radiation image detector illustrated in FIGS. 23A through 23C;

FIG. 24B is a diagram for describing the action of recording by the radiation image detector illustrated in FIGS. 23A through 23C;

FIG. 25 is a diagram for describing an action of reading out by the radiation image detector illustrated in FIGS. 23A through 23C;

FIG. 26 is a schematic diagram illustrating the structure of another embodiment of a radiation image detector used in the radiographic apparatus of the present invention;

FIG. 27A is a diagram for describing an action of recording by the radiation image detector illustrated in FIG. 26;

FIG. 27B is a diagram for describing the action of recording by the radiation image detector illustrated in FIG. 26;

FIG. 28 is a diagram for describing an action of reading out by the radiation image detector illustrated in FIG. 26;

FIG. 29 is a schematic diagram illustrating the structure of another embodiment of a radiation image detector used in the radiographic apparatus of the present invention; and

FIG. 30 is a diagram illustrating an example of the pattern of a charge storage layer according to an embodiment of a radiation image detector of the present invention.

### DESCRIPTION OF THE PREFERRED EMBODIMENTS

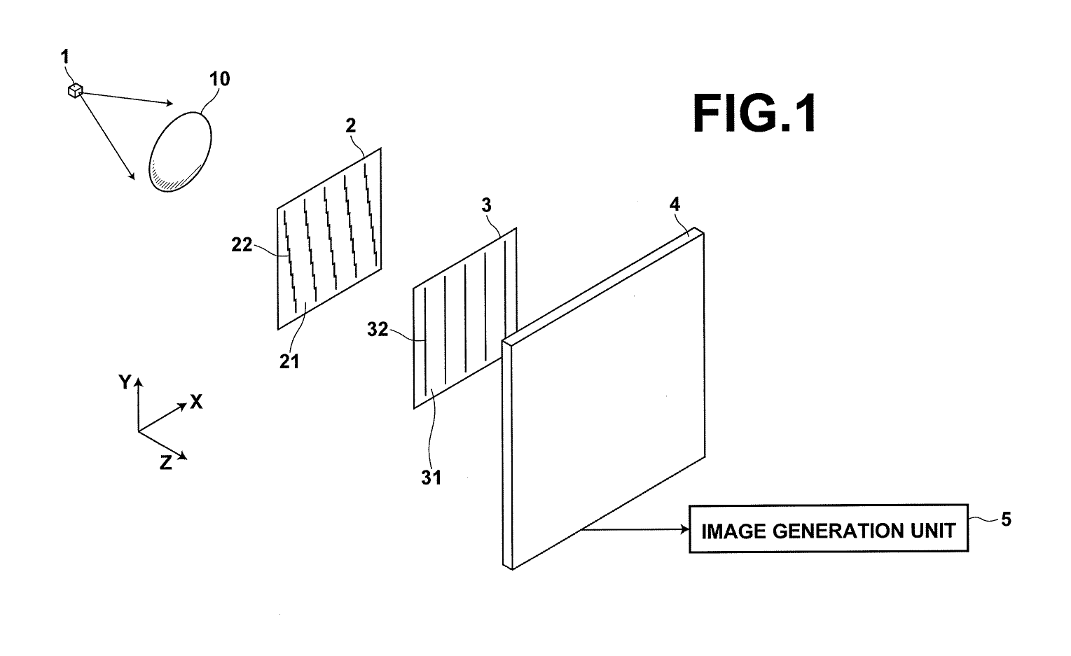

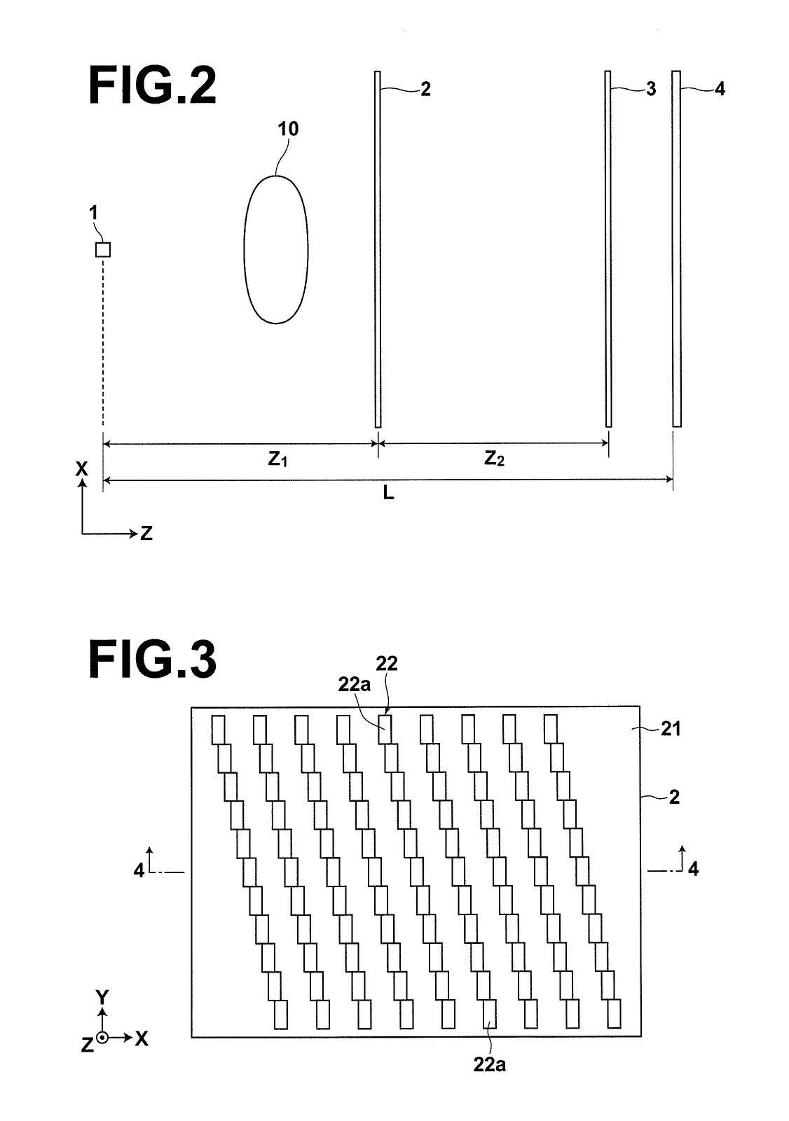

Hereinafter, a radiation phase image radiographic apparatus using a first embodiment of a radiographic apparatus of the present invention will be described with reference to drawings. FIG. 1 is a schematic diagram illustrating the structure of a radiation phase image radiographic apparatus according to the first embodiment of the present invention. FIG. 2 is a top view (X-Z cross section) of the radiation phase image radiographic apparatus illustrated in FIG. 1. The thickness direction of the paper of FIG. 2 is Y direction of FIG. 1.

As illustrated in FIG. 1, the radiation phase image radiographic apparatus includes a radiation source 1, a first grating 2, a second grating 3, a radiation image detector 4, and an image generation unit 5. The radiation source 1 outputs radiation toward a subject 10 to be examined. The first grating 2 forms a first periodic pattern image (hereinafter, referred to as self image G1) by passing the radiation that has been output from the radiation source 1. The second grating 3 forms a second periodic pattern image by modulating the intensity of the first periodic pattern image formed by the first grating 2. The radiation image detector 4 detects the second periodic pattern image formed by the second grating 3. The image generation unit 5 obtains a fringe image based on the second periodic pattern image detected by the radiation image detector 4, and generates a phase contrast image based on the obtained fringe image.

The radiation source 1 outputs radiation toward a subject 10 to be examined. The radiation source 1 has sufficient spatial coherence to produce a Talbot interference effect when the first grating 2 is irradiated with radiation. For example, a radiation source, such as a microfocus X-ray tube and a plasma X-ray source, which has a small-size radiation output point may be used as the radiation source 1.

As illustrated in FIG. 3, the first grating 2 includes a substrate 21 that mostly passes radiation and plural grating members 22 provided on the substrate 21. Each of the plural grating members 22 is composed of plural unit grating members 22a, and each of the plural unit grating members 22a is rectangular. The plural unit grating members 22a in each of the grating members 22 are arranged in Y direction in such a manner to be shifted, one by one, by a predetermined pitch in X direction. In other words, when the whole grating member 22 is observed, a grating pattern inclining with respect to Y direction at a predetermined angle is formed. Further, the grating member 22 is structured in such a manner that the unit grating members 22a adjacent to each other form a level difference (step) therebetween. In the present embodiment, X direction is the direction of pixel rows (pixel row direction) of the radiation image detector 4, which will be described later. Further, Y direction is the direction of pixel columns (pixel column direction) of the radiation image detector 4. The shift amount of each of the unit grating members 22a of the grating member 22 in X direction will be described later in detail.

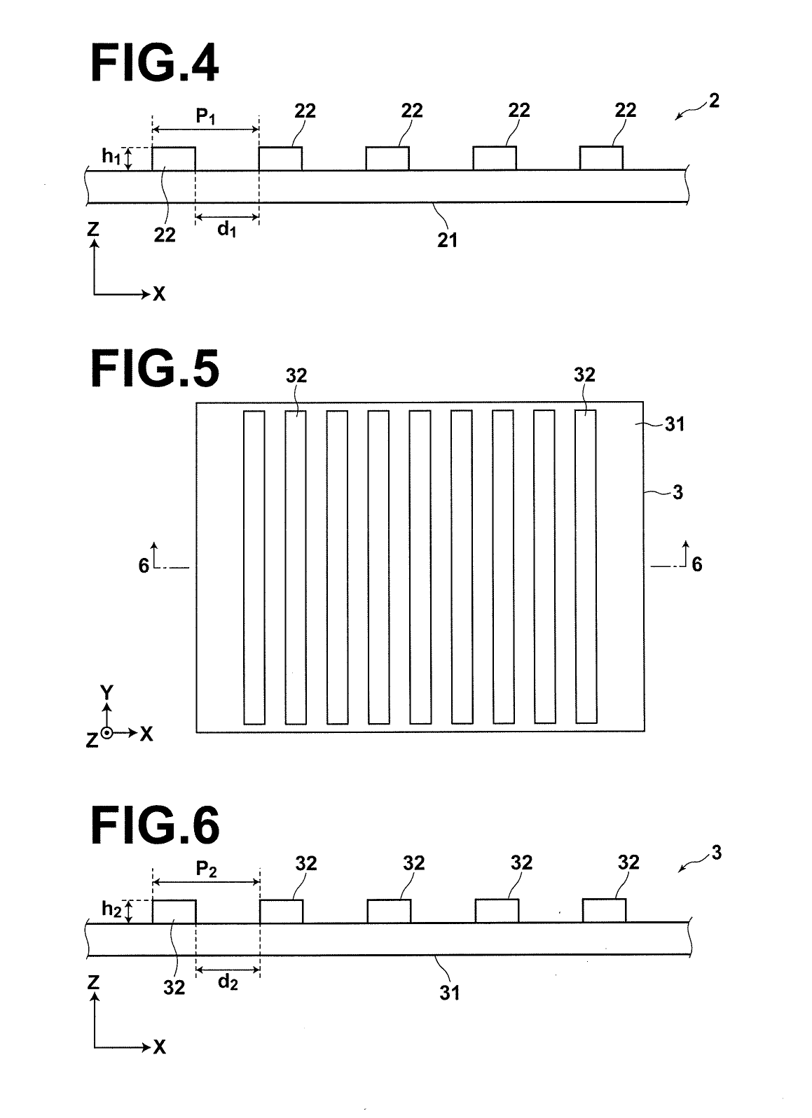

FIG. 4 is a cross section at line 4-4 of the first grating 2 illustrated in FIG. 3. Each of the unit grating members 22a constituting the grid member 22 is a rectangular member extended in an in-plane direction orthogonal to the optical axis of radiation (Y direction orthogonal to both of X direction and Z direction, and the thickness direction of the paper in FIG. 4). As illustrated in FIG. 4, the plural unit grating members 22a are arranged at constant cycle P₁ with predetermined interval d₁ therebetween in X direction. As the material of the unit grating members 22a, metal, such as gold and platinum, may be used, for example. Further, it is desirable that the first grating 2 is a so-called phase-modulation-type grating that modulates the phase of radiation irradiating the first grating 2 by approximately 90° or by approximately 180°. For example, when the unit grating members 22a are made of gold, thickness h₁ of the unit grating member 22a required in an X-ray energy range for ordinary medical diagnosis is approximately in the range of 1 μm to 10 μm. Alternatively, an amplitude-modulation-type grating may be used. In this case, it is necessary that the unit grating member 22a has a sufficient thickness to absorb radiation. For example, when the unit grating members 22a are made of gold, thickness h₁ of the unit grating member 22a required in an X-ray energy range for ordinary medical diagnosis is approximately in the range of 10 μm to hundreds of μm.

As illustrated in FIG. 5, the second grating 3 includes a substrate 31 that mostly passes radiation and plural grating members 32 provided on the substrate 31 in a manner similar to the first grating 2. The plural grating members 32 block radiation, and each of the plural grating members 32 is a linear member extending in an in-plane direction (Y direction orthogonal to both X direction and Z direction) orthogonal to the optical axis of radiation.

FIG. 6 is a cross section at line 6-6 of the second grating 3 illustrated in FIG. 5. As illustrated in FIG. 6, the plural grating members 32 are arranged at constant cycle P₂ with predetermined interval d₂ therebetween in X direction. As the material of the plural grating members 32, metal, such as gold and platinum, may be used, for example. It is desirable that the second grating 3 is an amplitude-modulation-type grating. In such a case, it is necessary that the grating member 32 has a sufficient thickness to absorb radiation. For example, when the grating members 32 are made of gold, thickness h₂ required in an X-ray energy range for ordinary medical diagnosis is approximately in the range of 10 μm to hundreds of μm.

Here, when radiation output from the radiation source 1 is not a parallel beam but a cone beam, self image G1 of the first grating 2 formed through the first grating 2 is magnified in proportion to a distance from the radiation source 1. Further, in the present embodiment, grating pitch P₂ of the second grating 3 is determined in such a manner that slit portions of the second grating 3 substantially coincide with a periodic pattern of light portions of the self image G1 of the first grating 2 at the position of the second grating 3. Specifically, as illustrated in FIG. 2, when a distance from the focal point of the radiation source 1 to the first grating 2 is Z₁, and a distance from the first grating 2 to the second grating 3 is Z₂, if the first grating 2 is a phase-modulation-type grating that modulates phase by 90° or an amplitude-modulation-type grating, grating pitch P₂ of the second grating 3 is determined so as to satisfy the following formula (1):

$$\begin{matrix}[ FORMULA 1 ] & \\ {P}_{2} = {P}_{1}^{′} = \frac{{Z}_{1} + {Z}_{2}}{{Z}_{1}} {P}_{1} , & ( 1 )\end{matrix}$$

where P₁′ is the pitch of self image G1 of the first grating 2 at the position of the second grating 3.

When the first grating 2 is a phase-modulation-type grating that modulates phase by 180°, grating pitch P₂ of the second grating 3 is determined so as to satisfy the following formula (2):

$$\begin{matrix}[ FORMULA 2 ] & \\ {P}_{2} = {P}_{1}^{′} = \frac{{Z}_{1} + {Z}_{2}}{{Z}_{1}} \cdot \frac{{P}_{1}}{2} , & ( 2 )\end{matrix}$$

When radiation output from the radiation source 1 is a parallel beam, if the first grating 2 is a phase-modulation-type grating that modulates phase by 90° or an amplitude-modulation-type grating, the pitch P₂ of the second grating 3 is determined so as to satisfy P₂=P₁-If the first grating 2 is a phase-modulation-type grating that modulates phase by 180°, the pitch P₂ of the second grating 3 is determined so as to satisfy P₂=P₁/2.

The radiation image detector 4 detects, as image signals, an image after intensity modulation by the second grating 3. Specifically, the second grating 3 modulates the intensity of self image G1 of the first grating 2, which is formed by radiation that has entered the first grating 2. In this embodiment, a direct-conversion-type radiation image detector using a so-called optical readout method is used as the radiation image detector 4. In the optical readout method, image signals are read out by scanning the detector with linear readout light.

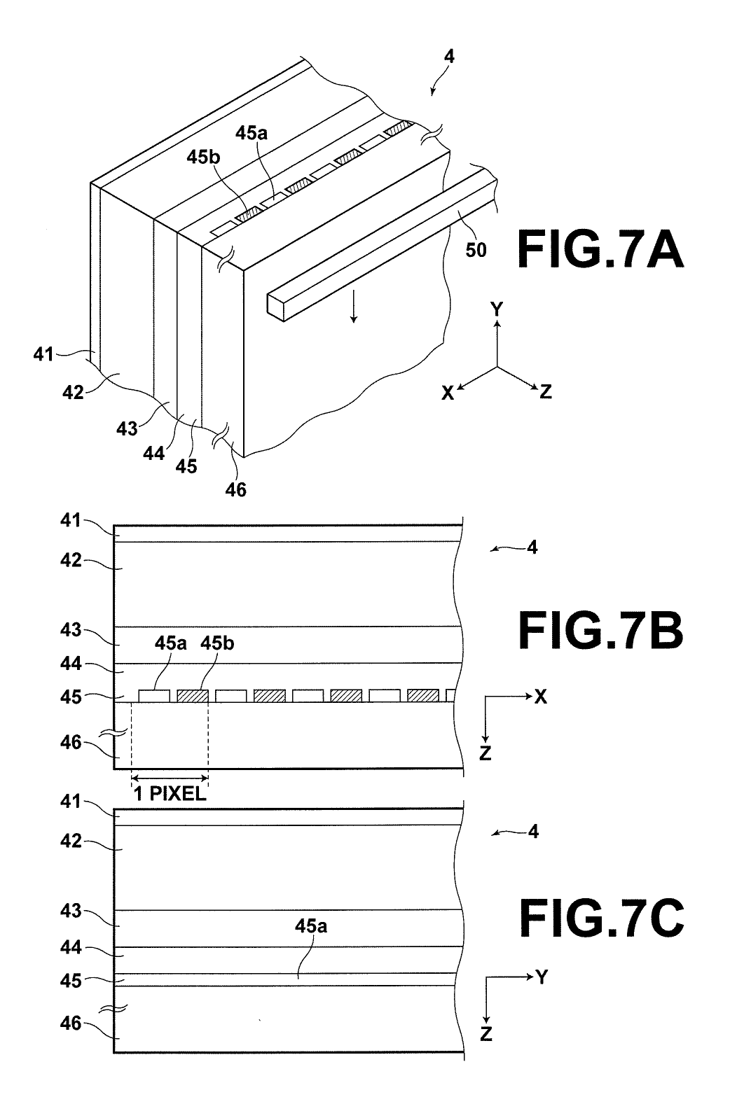

FIG. 7A is a perspective view of the radiation image detector 4 of the present embodiment. FIG. 7B is an XZ-plane cross section of the radiation image detector 4 illustrated in FIG. 7A. FIG. 7C is a YZ-plane cross section of the radiation image detector 4 illustrated in FIG. 7A.

As illustrated in FIGS. 7A through 7C, the radiation image detector 4 of the present embodiment includes a first electrode layer 41, a photoconductive layer 42 for recording, a charge storage layer 43, a photoconductive layer 44 for readout, and a second electrode layer 45, which are placed one on another in this order. The first electrode layer 41 passes radiation, and the photoconductive layer 42 for recording generates charges by irradiation with radiation that has passed through the first electrode layer 41. The charge storage layer 43 acts as an insulator for charges of one of the polarities of the charges generated in the photoconductive layer 42 for recording, and acts as a conductor for charges of the opposite polarity. Further, the photoconductive layer 44 for readout generates charges by illumination with readout light. These layers are formed on a glass substrate 46 in the mentioned order with the second electrode layer 45 at the bottom.

The first electrode layer 41 should pass radiation. For example, NESA coating (SnO₂), ITO (Indium Tin Oxide), IZO (Indium Zinc Oxide), IDIXO (Idemitsu Indium X-metal Oxide; Idemitsu Kosan, Co., Ltd.), which is an amorphous light-transmissive oxide coating, or the like may be formed in a thickness of 50 to 200 nm, as the first electrode layer 41. Alternatively, Al, Au, or the like with a thickness of 100 nm or the like may be used as the first electrode layer 41.

The photoconductive layer 42 for recording should generate charges by irradiation with radiation. A material containing a-Se, as amain component, may be used, because a-Se has a relatively high quantum efficiency with respect to radiation, and dark resistance is high. An appropriate thickness of the photoconductive layer 42 for recording is greater than or equal to 10 μm and less than or equal to 1500 μm. Especially, when the apparatus is used for mammography, it is desirable that the thickness of the photoconductive layer 42 for recording is greater than or equal to 150 μm and less than or equal to 250 μm. For general radiography use, it is desirable that the thickness of the photoconductive layer 42 for recording is greater than or equal to 500 μm and less than or equal to 1200 μm.

The charge storage layer 43 should have insulation properties with respect to charges having a polarity to be stored. The charge storage layer 43 may be made of polymers, such as an acryl-based organic resin, polyimide, BCB, PVA, acryl, polyethylene, polycarbonate and polyetherimide, sulfides, such as As₂S₃, Sb₂S₃ and ZnS, oxides, fluorides or the like. Further, it is more desirable that the charge storage layer 43 has insulation properties with respect to charges having a polarity to be stored, but conduction properties with respect to charges of the opposite polarity. Further, it is desirable to use a substance in which the product of mobility by lifetime differs, depending on the polarity of charges, at least by three digits.

Examples of an appropriate compound for the charge storage layer 43 are As₂Se₃, a compound obtained by doping As₂Se₃ with Cl, Br, or I in the range of 500 ppm to 20000 ppm, As₂(SeₓTe₁₋ₓ)₃ (0.5<x<1) which is obtained by substituting Se in As₂Se₃ with Te up to approximately 50%, a compound obtained by substituting Se in As₂Se₃ with S up to approximately 50%, AsₓSe_{y} (x+y=100, 34≦x≦46), which is obtained by changing the As concentration of As₂Se₃ by approximately ±15%, an amorphous Se—Te-based compound containing Te at 5 to 30 wt %, and the like.

It is desirable that the dielectric constant of the material of the charge storage layer 43 is greater than or equal to a half of the dielectric constants of the photoconductive layer 42 for recording and the photoconductive layer 44 for readout, and less than or equal to twice the dielectric constants of the photoconductive layer 42 for recording and the photoconductive layer 44 for readout so that an electric line of force formed between the first electrode layer 41 and the second electrode layer 45 does not curve.

The photoconductive layer 44 for readout should exhibit conductivity by receiving readout light. For example, a photoconductive material containing, as a main component, at least one of a-Se, Se—Te, Se—As—Te, non-metal phthalocyanine, metal phthalocyanine, MgPc (Magnesium phtalocyanine), VoPc (phase II of Vanadyl phthalocyanine), CuPc (Copper phtalocyanine), and the like is appropriate. It is desirable that the thickness of the photoconductive layer 44 for readout is approximately 5 to 20 μm.

The second electrode layer 45 includes plural transparent linear electrodes 45a, which pass readout light, and plural light-blocking linear electrodes 45b, which block the readout light. The transparent linear electrodes 45a and the light-blocking linear electrodes 45b continuously extend, in straight line shape, from an edge of an image formation area of the radiation image detector 4 to the opposite edge of the image formation area. As illustrated in FIGS. 7A and 7B, the transparent linear electrodes 45a and the light-blocking linear electrodes 45b are alternately arranged, parallel to each other, with a predetermined space therebetween.

The transparent linear electrodes 45a are made of a material that passes readout light and that has conductivity. For example, in a manner similar to the first electrode layer 41, ITO, IZO or IDIXO may be used. Further, the thickness of the transparent linear electrodes 45a is approximately 100 to 200 nm.

The light-blocking linear electrodes 45b are made of a material that blocks readout light and that has conductivity. For example, the aforementioned transparent conductive material and a color filter may be used in combination. The thickness of the transparent conductive material is approximately 100 to 200 nm.

As described later in detail, in the radiation image detector 4 of the present embodiment, an image signal is read out by using a pair of a transparent linear electrode 45a and a light-blocking linear electrode 45b arranged next to each other. Specifically, as illustrated in FIG. 7B, a pair of a transparent linear electrode 45a and a light-blocking linear electrode 45b is used to read out an image signal for a pixel. The transparent linear electrodes 45a and the light-blocking linear electrodes 45b are arranged so that a pixel is approximately 50 μm.

Further, as illustrated in FIG. 7A, a linear readout light source 50 that extends in a direction (X direction) orthogonal to a direction in which the transparent linear electrodes 45a and the light-blocking linear electrodes 45b extend is provided. The linear readout light source 50 includes a light source, such as an LED (Light Emitting Diode) or an LD (Laser Diode), and a predetermined optical system. The linear readout light source 50 is structured in such a manner to output linear readout light with a width of approximately 10 μm, in a direction (Y direction) parallel to a direction in which the transparent linear electrodes 45a and the light-blocking linear electrodes 45b extend, to the radiation image detector 4. The linear readout light source 50 is moved by a predetermined movement mechanism (not illustrated) in Y direction. By this movement of the linear readout light source 50, the radiation image detector 4 is scanned by linear readout light output from the linear readout light source 50, and image signals are read out. The action of reading out image signals will be described later.

A radiation phase image radiographic apparatus that can obtain a phase contrast image is composed of the radiation source 1, the first grating 2, the second grating 3, and the radiation image detector 4, as described above. Further, it is necessary that some other conditions are substantially satisfied to make the structure of the present embodiment function as a Talbot interferometer. Such conditions will be described.

First, it is necessary that the grid plane of the first grating 2 and the grid plane of the second grating 3 are parallel to X-Y plane illustrated in FIG. 1.

Further, when the first grating 2 is a phase-modulation-type grating that modulates phase by 90°, distance Z₂ between the first grating 2 and the second grating 3 must substantially satisfy the following condition:

$$\begin{matrix}[ FORMULA 3 ] & \\ {Z}_{2} = ( m + \frac{1}{2} ) \frac{{P}_{1} {P}_{2}}{λ} , & ( 3 )\end{matrix}$$

where λ is the wavelength of radiation (ordinarily, an effective wavelength), m is 0 or a positive integer, P₁ is a grating pitch of the first grating 2, as described above, and P₂ is a grating pitch of the second grating 3, as described above.

Further, when the first grating 2 is a phase-modulation-type grating that modulates phase by 180°, the following condition must be substantially satisfied:

$$\begin{matrix}[ FORMULA 4 ] & \\ {Z}_{2} = ( m + \frac{1}{2} ) \frac{{P}_{1} {P}_{2}}{2 λ} , & ( 4 )\end{matrix}$$

where λ is the wavelength of radiation (ordinarily, an effective wavelength), m is 0 or a positive integer, P₁ is a grating pitch of the first grating 2, as described above, and P₂ is a grating pitch of the second grating 3, as described above.

Alternatively, when the first grating 2 is an amplitude-modulation-type grating, the following condition must be substantially satisfied:

$$\begin{matrix}[ FORMULA 5 ] & \\ {Z}_{2} = {m}^{′} \frac{{P}_{1} {P}_{2}}{λ} , & ( 5 )\end{matrix}$$

where λ is the wavelength of radiation (ordinarily, an effective wavelength), m′ is a positive integer, P₁ is a grating pitch of the first grating 2, as described above, and P₂ is a grating pitch of the second grating 3, as described above.

The formulas (3), (4) and (5) are used when radiation output from the radiation source 1 is a cone beam. When the radiation output from the radiation source 1 is a parallel beam, the following formula (6) is used instead of the formula (3), and the following formula (7) is used instead of the formula (4), and the following formula (8) is used instead of the formula (5):

$$\begin{matrix}[ FORMULA 6 ] & \\ {Z}_{2} = ( m + \frac{1}{2} ) \frac{{P}_{1}^{2}}{λ} & ( 6 ) \\ [ FORMULA 7 ] & \\ {Z}_{2} = ( m + \frac{1}{2} ) \frac{{P}_{1}^{2}}{4 λ} & ( 7 ) \\ [ FORMULA 8 ] & \\ {Z}_{2} = {m}^{′} \frac{{P}_{1}^{2}}{λ} & ( 8 )\end{matrix}$$

As illustrated in FIGS. 4 and 5, the thickness of the grating members 22 of the first grating 2 is h₁, and the thickness of the grating members 32 of the second grating 3 is h₂. When the thickness h₁ and the thickness h₂ are too thick, radiation that diagonally enters the first grating 2 and the second grating 3 tends not to pass through slit portions, and so-called vignetting occurs. Consequently, an effective field of view in a direction (X direction) orthogonal to the direction in which the grating members 22, 32 extend becomes narrow. Therefore, it is desirable to regulate the upper limits of the thicknesses h₁, h₂ to maintain a sufficient field of view. It is desirable that the thicknesses h₁, h₂ are set so as to satisfy the formulas (9) and (10) to maintain length V of the effective field of view in X direction on the detection surface of the radiation image detector 4. Here, L is a distance from the focal point of the radiation source 1 to the detection surface of the radiation image detector 4 (please refer to FIG. 2):

$$\begin{matrix}[ FORMULA 9 ] & \\ {h}_{1} \leq \frac{L}{V / 2} {d}_{1} & ( 9 ) \\ [ FORMULA 10 ] & \\ {h}_{2} \leq \frac{L}{V / 2} {d}_{2} . & ( 10 )\end{matrix}$$

As described above, in the radiation phase image radiographic apparatus of the present embodiment, the unit grating members 22a constituting the grating members 22 of the first grating 2 are formed in such a manner to be shifted by a predetermined distance in X direction with respect to the grating members 32 of the second grating 3. The relationship between the amount of shift of each of the unit grating members 22a and the pixels of the radiation image detector 4 will be described.

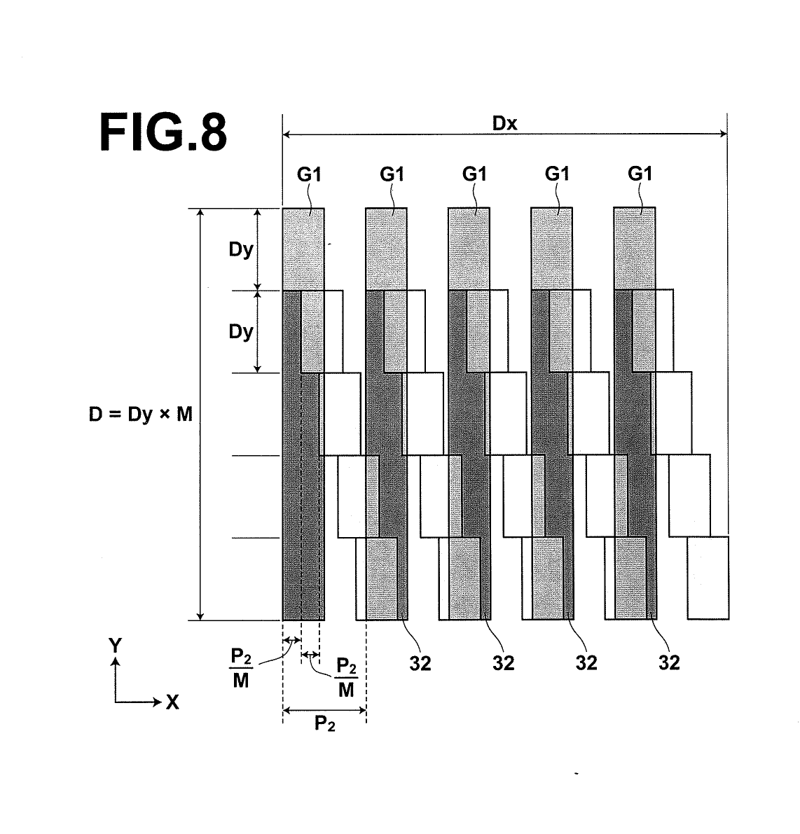

FIG. 8 is a diagram illustrating relationships among pixel size Dx (hereinafter, referred to as main pixel size) in X direction (pixel row direction) of the radiation image detector 4, pixel size Dy (hereinafter referred to as sub-pixel size) in Y direction (pixel column direction) of the radiation image detector 4, self image G1 of the first grating 2 formed by radiation that has passed through the first grating 2, and the grid members 32 of the second grating 3.

As described above, the main pixel size Dx is determined by the pitch of arrangement of the transparent linear electrodes 45a and the light-blocking linear electrodes 45b of the radiation image detector 4. In the present embodiment, the main pixel size Dx is set at 50 μm. Further, the sub-pixel size Dy is determined by the width of linear readout light that is output from the linear readout light source 50 and illuminates the radiation image detector 4. In the present embodiment, the sub-pixel size Dy is set at 10 μm.

In the present embodiment, plural fringe images that are different from each other are obtained based on an image detected by the radiation image detector 4, and a phase contrast image is generated based on the plural fringe images. When the number of fringe images to be obtained is M, M fringe images different from each other are obtained based on M sub-pixels (M is the number of sub-pixels) arranged in Y direction, as illustrated in FIG. 8. In other words, sub-pixel sizes Dy for M sub-pixels (Dy×M) is image resolution D of the phase contrast image in the sub scan direction.

Further, the size of each of the unit grating members 22a constituting the grating members of the first grating 2 in Y direction is set at sub-pixel size Dy, and the unit grating members 22a are arranged in Y direction in such a manner to be shifted, one by one, by a predetermined pitch in X direction so as to obtain M fringe images different from each other based on M sub-pixels arranged in Y direction as described above. Accordingly, as illustrated in FIG. 8, self images G1 of the unit grating members 22a are arranged in Y direction in such a manner to be shifted in X direction, one by one, by a predetermined pitch with respect to the grating members 32 of the second grating 3.

Specifically, as illustrated in FIG. 8, when the pitch of the second grating 3 and the pitch of the self image G1 of the unit grating members 22a in X direction formed at the position of the second grating 3 are P₂, and the image resolution of the phase contrast image in the sub scan direction is D=Dy×M, the unit grating members 22a are arranged in Y direction in such a manner to be shifted, one by one, by P₂/M, which is a value obtained by dividing pitch P₂ by M, in X direction. FIG. 8 illustrates a case in which the value of M is 5 (M=5).

When the unit grating members 22a are arranged as described above, the phase of the self image G1 of the first grating 2 and the phase of the second grating 3 are shifted by one cycle with respect to the length of the image resolution D in the sub scan direction. In FIG. 8, the phases are shifted by one cycle, but it is not necessary that the magnitude of shift is one cycle. The phases may be shifted by n cycles (n is an integer other than 0). However, a case in which the value of n is a multiple of M should be excluded, because the phase of the self image G1 of the first grating 2 and the phase of the second grating 3 become the same among a set of M sub scan direction pixels Dy, and different M fringe images are not formed.

Therefore, each pixel of Dx×Dy, obtained by dividing image resolution D in the sub scan direction of the phase contrast image by M, can detect an image signal obtainable by dividing an intensity-modulated self image G1 of the first grating 2 for one cycle by M.

Since M=5 in the present embodiment, each pixel of Dx×Dy can detect an image signal obtainable by dividing intensity-modulated self image G1 of the first grating 2 for one cycle by 5. In other words, pixels of Dx×Dy can detect image signals of five fringe images that are different from each other, respectively. The method for obtaining the image signals of five fringe images will be described later.

In the present embodiment, Dx=50 μm, Dy=10 μm, and M=5, as described above. Therefore, the image resolution Dx in the main scan direction of the phase contrast image and the image resolution D=Dy×M in the sub scan direction are the same. However, it is not necessary that the image resolution Dx in the main scan direction and the image resolution D in the sub scan direction are the same, and they may have an arbitrary ratio between the main scan direction and the sub scan direction. Further, in the present embodiment, the value of M is 5 (M=5). The value of M should be greater than or equal to 3, and may be a value different from 5.

The image generation unit 5 generates a radiation phase contrast image based on image signals of M kinds of fringe images that are different from each other, and which have been generated based on an image detected by the radiation image detector 4. A method for generating the radiation phase contrast image will be described later in detail.

Next, the action of the radiation phase image radiographic apparatus of the present embodiment will be described.

First, as illustrated in FIG. 1, after a subject 10 to be examined is placed between the radiation source 1 and the first grating 2, radiation is output from the radiation source 1. After the radiation passes through the subject 10 to be examined, the radiation irradiates the first grating 2. The radiation that has irradiated the first grating 2 is diffracted by the first grating 2. Accordingly, a Talbot interference image is formed at a position away from the first grating 2 by a predetermined distance in the optical axis direction of radiation.

This effect is called as a Talbot effect. When a light wave passes through the first grating 2, self image G1 of the first grating 2 is formed at a position away from the first grating 2 by a predetermined distance. For example, when the first grating 2 is a phase-modulation-type grating that modulates phase by 90°, self image G1 of the first grating 2 is formed at a distance given by the formula (3) or (6) (when a phase-modulation-type grating that modulates phase by 180° is used, a distance given by the formula (4) or (7), and when an intensity-modulation-type grating is used, a distance given by the formula (5) or (8)). Since the wavefront of radiation entering the first grating 2 is distorted by the subject 10 to be examined, the self image G1 of the first grating 2 is deformed based on the distortion.

Then, radiation passes through the second grating 3. Consequently, the deformed self image G1 of the first grating 2 is superimposed on the second grating 3, and the intensity of the deformed self image G1 is modulated. The deformed self image G1 is detected by the radiation image detector 4, as image signals reflecting the distortion of the wavefront.

Next, the actions of image detection and readout by the radiation image detector 4 will be described.

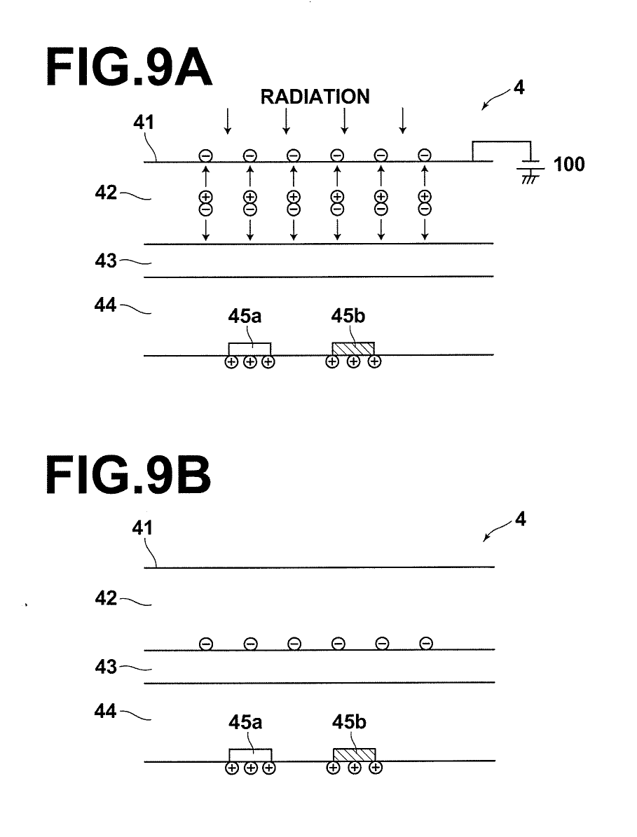

First, as illustrated in FIG. 9A, negative voltage is applied to the first electrode layer 41 of the radiation image detector 4 by a high voltage source 100. While the negative voltage is applied, radiation the intensity of which has been modulated by placing (superposing, superimposing, or the like) the self image G1 of the first grating 2 on the second grating 3 irradiates the radiation image detector 4 from the first electrode layer 41 side.

Further, radiation that has irradiated the radiation image detector 4 passes through the first electrode layer 41, and irradiates the photoconductive layer 42 for recording. A pair of charges is generated in the photoconductive layer 42 for recording by irradiation with the radiation. A positive charge of the charge pair is combined with a negative charge in the first electrode layer 41, and disappears. A negative charge of the charge pair is stored in the charge storage layer 43 as a latent image charge (please refer to FIG. 9B).

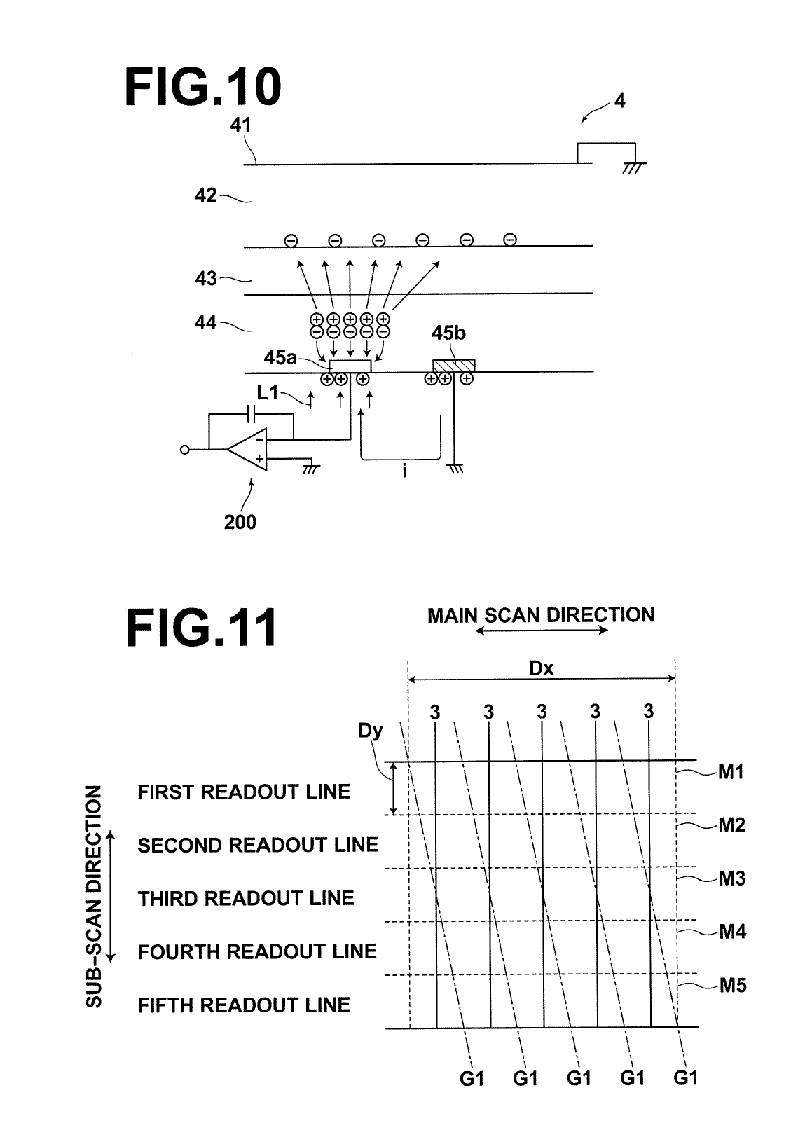

Further, as illustrated in FIG. 10, while the first electrode layer 41 is earthed, linear readout light L1 output from the linear readout light source 50 illuminates the radiation image detector 4 from the second electrode layer 45 side. The readout light L1 passes through the transparent linear electrodes 45a, and illuminates the photoconductive layer 44 for readout. Positive charges generated in the photoconductive layer 44 for readout by illumination with the readout light L1 are combined with latent image charges stored in the charge storage layer 43, and negative charges generated in the photoconductive layer 44 for readout are combined with positive charges in the light-blocking linear electrodes 45b through the charge amplifier 200 connected to the transparent linear electrodes 45a.

When the negative charges generated in the photoconductive layer 44 for readout are combined with the positive charges in the light-blocking linear electrodes 45b, an electric current flows to the charge amplifier 200. The electric current is integrated, and detected as image signals.

Further, the linear readout light source 50 moves in the sub scan direction, and the radiation image detector 4 is scanned by the linear readout light L1. Accordingly, image signals are sequentially read out, line by line, by the action as described above. The image signals are read out from each readout line illuminated with the linear readout light L1. Further, the image signals detected from each readout line are sequentially input to the image generation unit 5, and stored.

Further, after the entire area of the radiation image detector 4 is scanned with readout light L1, and image signals for a whole one frame are stored in the image generation unit 5, image signals representing five fringe images that are different from each other are obtained by the image generation unit 5 based on the stored image signals.

Specifically, in the present embodiment, as illustrated in FIG. 8, image resolution D in sub scan direction of the phase contrast image is divided by 5, and the unit grating members 22a of the first grating 2 are arranged in such a manner that image signals obtainable by dividing intensity-modulated self image G1 of the first grating 2 for one cycle by 5 are detectable. In such a case, as illustrated in FIG. 11, an image signal read out from a first readout line is obtained as first fringe image signal M1, an image signal read out from a second readout line is obtained as second fringe image signal M2, an image signal read out from a third readout line is obtained as third fringe image signal M3, an image signal read out from a fourth readout line is obtained as fourth fringe image signal M4, and an image signal read out from a fifth readout line is obtained as fifth fringe image signal M5. The first through fifth readout lines illustrated in FIG. 11 correspond to sub-pixel size Dy illustrated in FIG. 8.

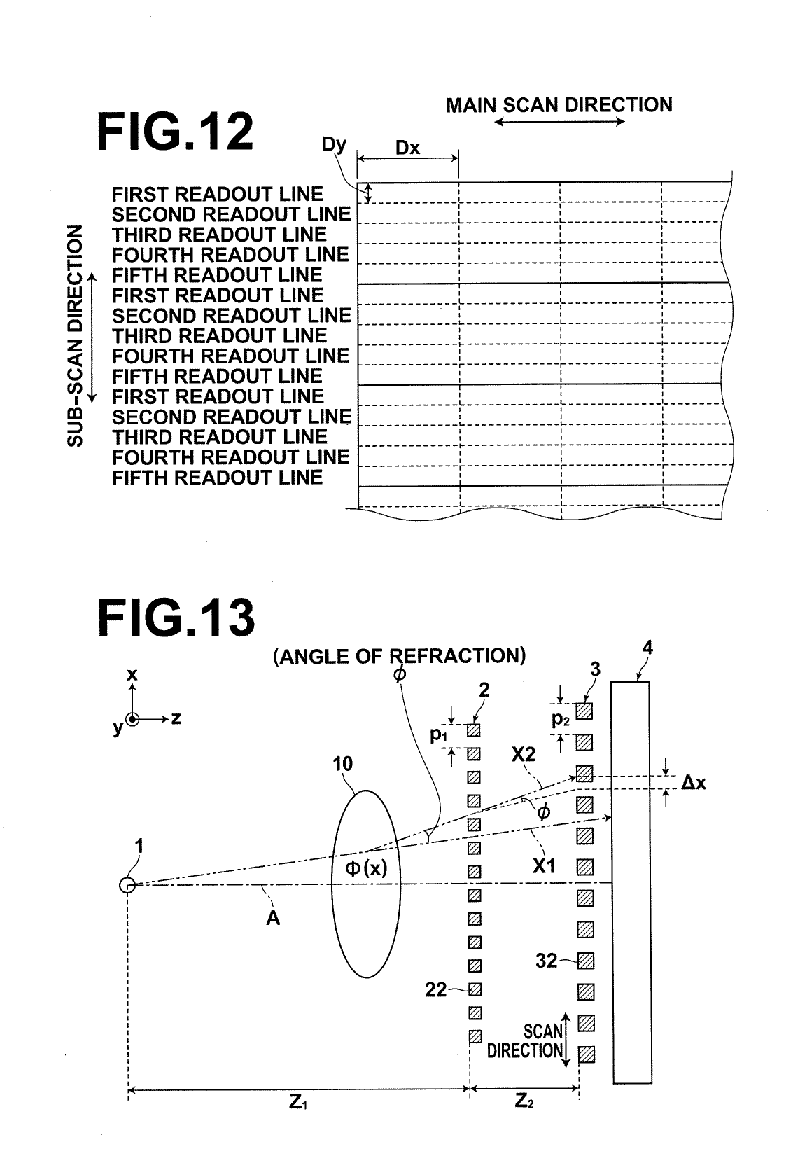

FIG. 11 illustrates only a readout range of Dx×(Dy×5). However, the first through fifth fringe image signals are obtained also in other readout ranges in a similar manner. Specifically, as illustrated in FIG. 12, image signals representing a group of pixel rows (readout lines) with 4 pixel intervals between pixel rows in the sub scan direction are obtained, as a frame of one-fringe-image signal. More specifically, image signals of a group of pixel rows of first readout lines are obtained, as a frame of first fringe image signal. Image signals of a group of pixel rows of second readout lines are obtained, as a frame of second fringe image signal. Image signals of a group of pixel rows of third readout lines are obtained, as a frame of third fringe image signal. Image signals of a group of pixel rows of fourth readout lines are obtained, as a frame of fourth fringe image signal. Image signals of a group of pixel rows of fifth readout lines are obtained, as a frame of fifth fringe image signal.

As described above, image signals representing first through fifth fringe images that are different from each other are obtained. Further, the image generation unit 5 generates a phase contrast image based on the image signals representing the first through fifth fringe images.

Next, a method for generating a phase contrast image at the image generation unit 5 will be described. First, the principle of the method for generating a phase contrast image in the present embodiment will be described.

FIG. 13 is a diagram illustrating an example of a path of a ray of radiation refracted based on phase shift distribution Φ(x) related to X direction of subject 10 to be examined. In FIG. 13, sign X1 indicates a path of radiation when subject 10 to be examined is not present, and the radiation travels straight. The radiation traveling through the path X1 passes through the first grating 2 and the second grating 3, and enters the radiation image detector 4. Sign X2 indicates a path of radiation when the subject 10 to be examined is present, and the radiation has been refracted by the subject 10 to be examined and deflected. The radiation traveling through the path X2 passes through the first grating 2, and is blocked by the second grating 3.

The phase shift distribution Φ(x) of the subject 10 to be examined is represented by the following formula (11) when the distribution of refractive index of the subject 10 to be examined is n(x,z), and the direction in which radiation travels is z. Here, y coordinate is omitted to simplify explanation.

$$\begin{matrix}[ FORMULA 11 ] & \\ Φ ( x ) = \frac{2 π}{λ} \int [ 1 - n ( x , z ) ] d z & ( 11 )\end{matrix}$$

Self image G1 of the first grating 2 formed at the position of the second grating 3 is displaced by refraction of radiation by the subject 10 to be examined. The self image G1 is displaced, in X direction, by an amount corresponding to angle φ of refraction of radiation. Displacement amount Δx is approximated by the following formula (12) based on the premise that the angle φ of refraction of radiation is minute:

### [FORMULA 12]

Δx≈Z₂φ (12)

Here, the angle φ of refraction is represented by the following formula (13) by using wavelength λ of radiation and phase shift distribution Φ(x) of the subject 10 to be examined:

$$\begin{matrix}[ FORMULA 13 ] & \\ ϕ = \frac{λ}{2 π} \frac{\partial Φ ( x )}{\partial x} . & ( 13 )\end{matrix}$$

As described above, displacement amount Δx of self image G1 by refraction of radiation by the subject 10 to be examined is related to phase shift distribution Φ(x) of the subject 10 to be examined. Further, the displacement amount Δx is related to phase shift amount Ψ of an intensity-modulated signal of each pixel detected by the radiation image detector 4 (a phase shift amount of an intensity-modulated signal of each pixel between a case with subject 10 to be examined and a case without the subject 10 to be examined), as represented in the follow'ing formula (14):

$$\begin{matrix}[ FORMULA 14 ] & \\ ψ = \frac{2 π}{{P}_{2}} Δ x = \frac{2 π}{{P}_{2}} {Z}_{2} ϕ . & ( 14 )\end{matrix}$$

Therefore, it is possible to obtain angle φ of refraction by obtaining phase shift amount Ψ of the intensity-modulated signal of each pixel by the formula (14). Further, the differential value of phase shift distribution Φ(x) is obtainable by using the formula (13). Further, it is possible to obtain phase shift distribution Φ(x) of the subject 10 to be examined by integrating the differential value with respect to x. In other words, it is possible to generate a phase contrast image of the subject 10 to be examined. In the present embodiment, the phase shift amount Ψ is calculated based on the first through fifth fringe image signals, as described above, by using a fringe scan method, which will be described below.

In the present embodiment, image resolution D in the sub scan direction of the phase contrast image is divided by 5. Therefore, five kinds of fringe image signals, namely, first through fifth fringe image signals are obtained for each pixel of the phase contrast image. Next, a method for calculating phase shift amount Ψ of an intensity-modulated signal of each pixel of the phase contrast image based on the five kinds of fringe image signals (first through fifth fringe image signals) will be described. Here, the method is not limited to calculating based on five kinds of fringe image signals, and the method for calculating phase shift amount Ψ based on M kinds of fringe image signals will be described.

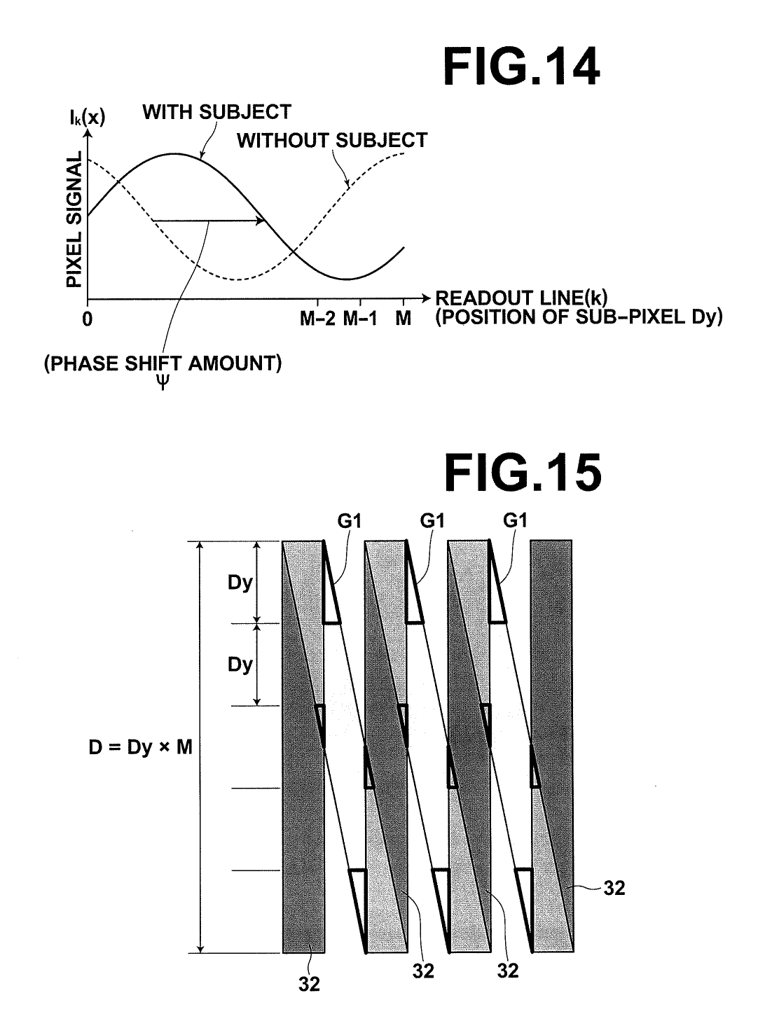

First, pixel signal Ik (x) of each pixel arranged, at k-th readout line, in the main scan direction of the radiation image detector 4, as illustrated in FIG. 14, is represented by the following formula (15):

$$\begin{matrix}[ FORMULA 15 ] & \\ {I}_{k} ( x ) = {A}_{0} + {\sum }_{n > 0} {A}_{n} exp [ 2 π i \frac{n}{{P}_{2}} \{ {Z}_{2} ϕ ( x ) + \frac{{kP}_{2}}{M} \} ] . & ( 15 )\end{matrix}$$

Here, x represents the coordinate of a pixel related to x direction, and A₀ represents the intensity of incident radiation. Aₙ is a value corresponding to the contrast of the intensity-modulated signal (here, n is a positive integer). Further, φ (x) is the angle φ of refraction represented as a function of coordinate x of a pixel of the radiation image detector 4.

Next, when a relational equation represented by the following formula (16) is used, the angle φ(x) of refraction is represented as in formula (17):

$$\begin{matrix}[ FORMULA 16 ] & \\ {\sum }_{k = 0}^{M - 1} exp ( - 2 π i \frac{k}{M} ) = 0 & ( 16 ) \\ [ FORMULA 17 ] & \\ ϕ ( x ) = \frac{{p}_{2}}{2 π {Z}_{2}} arg [ {\sum }_{k = 0}^{M - 1} {I}_{k} ( x ) exp ( - 2 π i \frac{k}{M} ) ] . & ( 17 )\end{matrix}$$

Here, “arg[ ]” means extraction of an argument, which corresponds to phase shift amount Ψ of each pixel of the phase contrast image. Therefore, it is possible to obtain angle φ(x) of refraction by calculating, based on the formula (17), the phase shift amount Ψ the intensity-modulated signal of each pixel of the phase contrast image from the pixel signals of the M fringe image signals obtained for each pixel of the phase contrast image.

Specifically, as illustrated in FIG. 14, M pixel signals obtained for M sub-pixels Dy constituting each pixel of the phase contrast image periodically change, at a cycle of M×sub-pixel Dy, with respect to the position of a readout line (position of sub-pixel Dy). Therefore, fitting is performed on a string of M pixel signals of the sub-pixel Dy, for example, by a sinusoidal wave, and phase shift amount Ψ of the fitting curve between a case in which a subject to be examined is present and a case in which the subject to be examined is not present is obtained. Further, the differential value of phase shift distribution Φ(x) is obtainable by using the formulas (13) and (14), and the differential value is integrated with respect to x. Accordingly, the phase shift distribution Φ(x) of the subject 10 to be examined, in other words, a phase contrast image of the subject 10 to be examined is generated.

In obtainment of the fitting curve, the sinusoidal wave may be used typically, as described above. Alternatively, a square wave or a triangle wave may be used.

In the above descriptions, y coordinates related to y direction of pixels in the phase contrast image were not considered. However, it is possible to obtain two-dimensional distribution φ(x,y) of the angle of refraction by performing a similar operation also for each y coordinate. Further, it is possible to obtain two-dimensional phase shift distribution Φ(x,y) by integrating the two-dimensional distribution φ(x,y) along x axis.

Alternatively, the phase contrast image may be generated by integrating two-dimensional distribution Ψ(x,y) of the phase shift amount along x axis, instead of the two-dimensional distribution φ(x,y) of the angle of refraction.

Since the two-dimensional distribution φ(x,y) of the angle of refraction and the two-dimensional distribution Ψ(x,y) of the phase shift amount correspond to the differential value of phase shift distribution Φ(x,y), they are called as phase differential images. The phase differential images may be generated as phase contrast images.

According to the radiation phase image radiographic apparatus of the present embodiment, plural unit grating members 22a of the first grating 2 are arranged in Y direction in such a manner to be shifted, parallel to each other, in X direction by distances different from each other with respect to the second grating 3. Further, image signals readout from groups of pixel rows, the groups being different from each other, are obtained as image signals representing fringe images different from each other, and a phase contrast image is generated based on the obtained image signals representing the plural fringe images. Therefore, unlike conventional techniques, it is not necessary to provide a highly accurate movement mechanism for moving the second grating 3, and plural fringe images for obtaining a phase contrast image are obtainable by one radiography operation.

In the present embodiment, the plural fringe images are obtained by arranging the plural unit grating members 22 constituting the first grating 2 in Y direction in such a manner to be shifted, one by one, by a predetermined distance in X direction. However, it is not necessary that the apparatus is structured in such a manner. For example, each of the grating members 22 constituting the first grating 2 may have a simple linear shape, and they may be structured in such a manner that self image G1 of each of the grating members 22 of the first grating 2 inclines, by a predetermined angle, with respect to each of the grating members 32 of the second grating 3, as illustrated in FIG. 15. In this case, it is possible to detect fringe images different from each other for each pixel of Dx×Dy in a manner similar to the above embodiment. However, when the apparatus is structured in such a manner, it is desirable that self image G1 of the first grating 2 and the grating members 32 of the second grating 3 completely coincide with each other, for example, at pixels illustrated at the top and at the bottom of FIG. 15. However, regions of the self image G1 of the first grating 2 indicated by triangles leak, and the contrast of the fringe image becomes lower because of the leakage. Further, it is desirable self image G1 of the first grating 2 and the grating members 32 of the second grating 3 are completely separated from each other at third pixels from the top of FIG. 15. In other words, it is desirable that the whole self image G1 passes through the grating members 32. However, in regions indicated by triangles, the self image G1 of the first grating 2 is blocked by the grating members 32. Therefore, the contrast of the fringe image becomes lower because of the blockage.

If the contrast of the fringe image becomes lower as described above, an operation error occurs when a phase contrast image is generated. Consequently, the image quality of the phase contrast image becomes lower.

In contrast, in the present embodiment, the plural unit grating members 22a constituting the first grating 2 are arranged in Y direction in such a manner to be shifted, one by one, by a predetermined distance in X direction. Therefore, it is possible to prevent leakage and blockage of the self image G1 of the first grating 2 as described above. Hence, it is possible to obtain a phase contrast image having an excellent image quality.

Next, a radiation phase image radiographic apparatus using a second embodiment of the radiographic apparatus of the present invention will be described. The radiation phase image radiographic apparatus in the first embodiment is structured to satisfy at least one of the formulas (3) to (8) based on the type of the first grating 2 and a scattering angle of radiation output from the radiation source 1 to make distance Z₂ from the first grating 2 to the second grating 3 become a Talbot interference distance. However, in the radiation phase image radiographic apparatus of the second embodiment, the first grating 2 is structured in such a manner to project radiation entering the first grating 2 without diffracting most of the radiation. Accordingly, similar projection images of radiation that has passed through the first grating 2 are obtainable at positions on the rear side of the first grating 2. Therefore, it is possible to set the distance Z₂ from the first grating 2 to the second grating 3 without regard to the Talbot interference distance.

Specifically, in the radiation phase image radiographic apparatus of the second embodiment, both the first grating 2 and the second grating 3 are structured as absorption-type (amplitude modulation type) gratings. Further, the apparatus is structured in such a manner that radiation that has passed through a slit portion is geometrically projected without regard to whether a Talbot interference effect is present or not. More specifically, it is possible to structure the apparatus so that most of radiation output from the radiation source 1 is not diffracted by the slit portions and self image G1 of the first grating 2 is formed on the rear side of the first grating 2 by setting, as interval d₁ of the first grating 2 and interval d₂ of the second grating 3, values sufficiently larger than the effective wavelength of radiation output from the radiation source 1. For example, when tungsten is used as a target of the radiation source, and tube voltage is 50 kV, the effective wavelength of radiation is approximately 0.4 Å. In this case, when the interval d₁ of the first grating 2 and the interval d₂ of the second grating 3 are approximately in the range of 1 μm to 10 μm, the diffraction effect on a radiation image formed by radiation that has passed through the slit portions is at an ignorable level. Therefore, self image G1 of the first grating 2 is geometrically projected on the rear side of the first grating 2.

With respect to the relationship between grating pitch P₁ of the first grating 2 and grating pitch P₂ of the second grating 3, the apparatus is structured in a manner similar to formula (1) in the first embodiment. Further, the arrangement of the unit grating members 22a constituting the first grating 2 with respect to the second grating 3 is similar to the first embodiment.

In the second embodiment, distance Z₂ between the first grating 2 and the second grating 3 may be set shorter than a minimum Talbot interference distance when m′=1 in the formula (5). Specifically, the distance Z₂ is set so as to satisfy the range represented by the following formula (18):

$$\begin{matrix}[ FORMULA 18 ] & \\ {Z}_{2} < \frac{{P}_{1} {P}_{2}}{λ} . & ( 18 )\end{matrix}$$

It is desirable that the grating members 22 of the first grating 2 and the grating members 32 of the second grating 3 completely block (absorb) radiation to generate a high-contrast periodic pattern image. However, even if a material (gold, platinum or the like) that excellently absorbs radiation is used, the amount of radiation that passes through the gratings without being absorbed is not small. Therefore, it is desirable that thicknesses h₁, h₂ of the grating members 22, 32 are as thick as possible to increase the radiation blocking characteristic of the grating members 22, 32. It is desirable that the grating members 22, 32 block at least 90% of radiation that has irradiated the grating members 22, 32. The materials and thicknesses h₁, h₂ of the grating members 22, 32 are set based on the energy of radiation that irradiates the grating members 22, 32. For example, when tungsten is used as a target of the radiation source, and the tube voltage is 50 kV, it is desirable that the thicknesses h₁, h₂ are greater than or equal to 100 μm in gold (Au) equivalent.

However, a problem of so-called vignetting of radiation exists also in the second embodiment in a manner similar to the first embodiment. Therefore, it is desirable to regulate the thicknesses h₁, h₂ of the grating members 22 of the first grating 2 and the grating members 32 of the second grating 3.

In the radiation phase image radiographic apparatus of the second embodiment, radiation is output from the radiation source 1 after the subject 10 to be examined is placed between the radiation source 1 and the first grating 2, also as illustrated in FIG. 1. The radiation passes through the subject 10 to be examined, and irradiates the first grating 2.

Then, a projection image formed by passage of radiation through the first grating 2 is projected onto the second grating 3, and the projection image passes through the second grating 3. As a result, the intensity of the projection image is modulated by placement of the projection image on the second grating 3, and the projection image is detected, as image signals, by the radiation image detector 4.

The image signals detected by the radiation image detector 4 are read out in a manner similar to the first embodiment. After image signals for a whole one frame are stored in the image generation unit 5, the image generation unit 5 obtains, based on the stored image signals, image signals representing five fringe images that are different from each other in a manner similar to the first embodiment.

The action for generating the phase contrast image at the image generation unit 5 is also similar to the first embodiment.

According to the radiation phase image radiographic apparatus of the second embodiment, it is possible to make distance Z₂ between the first grating 2 and the second grating 3 shorter than a Talbot interference distance. Therefore, it is possible to further reduce the thickness of the radiographic apparatus, compared with the radiation phase image radiographic apparatus in the first embodiment that needs to maintain a certain Talbot interference distance.

Further, in the first embodiment and the second embodiment, when a distance from the radiation source 1 to the radiation image detector 4 is a distance (1 m through 2 m) as set in a radiography room of an ordinary hospital, if the size of the focal point of the radiation source 1 is, for example, approximately in the range of 0.1 mm to 1 mm, which is general, blurs may be generated in self image G1 of the first grating 2 by Talbot interference or projection of the first grating 2. Consequently, there is a risk of lowering the image quality of the phase contrast image.

Therefore, when the radiation source 1 that has the focal point of the aforementioned size is used, a pinhole may be set immediately after the focal point of the radiation source 1 to reduce the effective size of the focal point. However, if the area of the opening of the pinhole is reduced to reduce the effective size of the focal point, the intensity of radiation becomes lower.

Therefore, instead of setting the pinhole as described above, a multi-slit may be arranged immediately after the focal point of the radiation source 1 in the radiation phase image radiographic apparatuses according to the first and second embodiments.

Here, the multi-slit is an absorption-type grating that is structured in a similar manner to the first grating 2 and the second grating 3 in the second embodiment. In the multi-slit, plural radiation-blocking portions extending in a predetermined direction are periodically arranged. It is desirable that the arrangement direction of the radiation-blocking portions arranged in the multi-slit is the same as one of the arrangement direction of the members 22 in the first grating 2 and the arrangement direction of the members 32 in the second grating 3. However, for a purpose of obtaining a phase contrast image, it is not necessary that the arrangement direction of the radiation-blocking portions in the multi-slit is the same as one of the arrangement direction of the members 22 in the first grating 2 and the arrangement direction of the members 32 in the second grating 3. In the descriptions of the present embodiment, a most desirable mode is used as an example, and it is assumed that the arrangement direction of the radiation-blocking portions arranged in the multi-slit is the same as the arrangement direction (X direction) of the members 22 of the first grating 2.

Specifically, in this case, the multi-slit can reduce the effective size of the focal point in X direction by partially blocking radiation that is radiated from the focal point of the radiation source 1. Further, the multi-slit can form many pseudo-very-small-focal-point light sources divided in X direction.

The grating pitch P₃ of the multi-slit needs to satisfy the following formula (19) when the distance from the multi-slit to the first grating 2 is Z₃:

$$\begin{matrix}[ FORMULA 19 ] & \\ {P}_{3} = \frac{{Z}_{3}}{{Z}_{2}} {P}_{1}^{′} , & ( 19 )\end{matrix}$$

where P₁′ is an arrangement pitch of the self image G1 of the first grating 2 at the position of the radiation image detector.

Even if the multi-slit is provided, the base point of the enlargement ratio of the self image G1 of the first grating 2 is the position of the focal point of the radiation source 1. Therefore, the relationship that should be satisfied by grating pitch P₂ of the second grating 3 is similar to those to be satisfied in the first and second embodiments. Specifically, when the first grating 2 is a phase-modulation-type grating that modulates phase by 90° or an amplitude-modulation-type grating, the grating pitch P₂ is determined so as to satisfy the following formula (20):

$$\begin{matrix}[ FORMULA 20 ] & \\ {P}_{2} = {P}_{1}^{′} = \frac{{Z}_{1} + {Z}_{2}}{{Z}_{1}} {P}_{1} . & ( 20 )\end{matrix}$$

Further, when the first grating 2 is a phase-modulation-type grating that modulates phase by 180°, the grating pitch P₂ is determined so as to satisfy the following formula (21):

$$\begin{matrix}[ FORMULA 21 ] & \\ {P}_{2} = {P}_{1}^{′} = \frac{{Z}_{1} + {Z}_{2}}{{Z}_{1}} \cdot \frac{{P}_{1}}{2} . & ( 21 )\end{matrix}$$

Further, when a distance from the focal point of the radiation source 1 to the radiation image detector 4 is L, it is desirable that the thickness h₁ of the grating member 22 of the first grating 2 and thickness h₂ of the grating member 32 of the second grating 3 are determined so as to satisfy the formulas (22) and (23) to maintain length V of the effective field of view in X direction on the detection surface of the radiation image detector 4:

$$\begin{matrix}[ FORMULA 22 ] & \\ {h}_{1} \leq \frac{L}{V / 2} {d}_{1} & ( 22 ) \\ [ FORMULA 23 ] & \\ {h}_{2} \leq \frac{L}{V / 2} {d}_{2} . & ( 23 )\end{matrix}$$

Formula (19) defines geometric conditions for making plural self images G1 of the first grating 2 formed by Talbot interference induced by radiation output from each of pseudo-very-small-focal-point light sources, which are dispersedly formed by the multi-slit, and projection of the radiation superposed one on another at the position of the second grating 3. The plural self images G1 are shifted from each other exactly by one cycle of pitch of the self image G1 of the first grating 2, and superposed. As described above, the multi-slit forms plural very small focal point light sources. Since plural self images G1 of the first grating 2 are superposed one on another regularly by the Talbot interference and the projection, it is possible to prevent the intensity of radiation from becoming lower. Hence, it is possible to improve the image quality of the phase contrast image.

In the first embodiment and the second embodiment, a so-called optical readout type radiation image detector is used as the radiation image detector 4. The optical readout type radiation image detector is scanned with linear readout light output from a linear readout light source 50 to read out image signals therefrom. However, it is not necessary that the optical readout type radiation image detector is used. For example, a radiation image detector using TFT switches, as disclosed in Japanese Unexamined Patent Publication No. 2002-26300, a radiation image detector using a CMOS sensor, or the like may be used. In the radiation image detector using TFT switches, many TFT switches are two-dimensionally arranged, and image signals are read out from the radiation image detector by ON/OFF of the TFT switches.

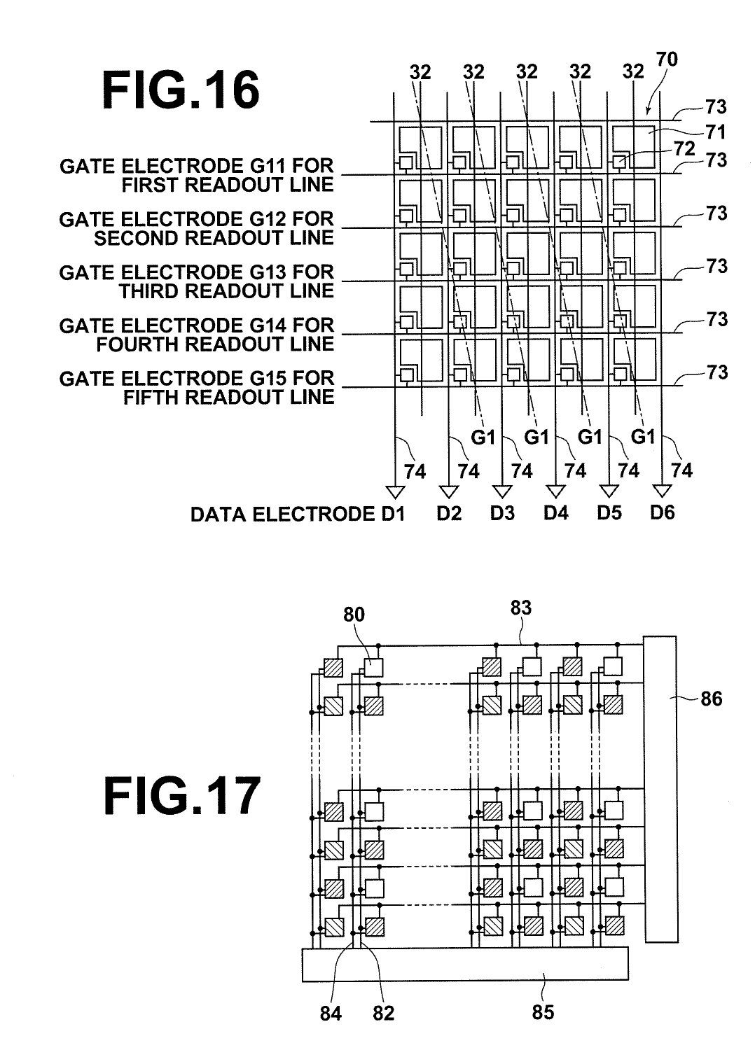

Specifically, in the radiation image detector using the TFT switches, many pixel circuits 70 are two-dimensionally arranged, for example, as illustrated in FIG. 16. The pixel circuit 70 includes a pixel electrode 71 and a TFT switch 72. The pixel electrode 71 collects charges that have been generated by photoelectric conversion at a semiconductor layer by irradiation with radiation, and the TFT switch 72 is used to read out the charges collected by the pixel electrode 71 as image signals. Further, the radiation image detector using the TFT switches includes many gate electrodes 73 and many data electrodes 74. The gate electrode 73 is provided for each pixel circuit row, and a gate scan signal for controlling ON/OFF of the TFT switch 72 is output from the gate electrode 73. The data electrode 74 is provided for each pixel circuit column, and charge signals read out from each pixel circuit 70 are output from the data electrode 74. The structure of layers of each pixel circuit 70 in detail is similar to the structure of layers disclosed in Japanese Unexamined Patent Publication No. 2002-26300.

For example, when the second grating 3 and the pixel circuit columns (data electrodes) are set parallel to each other, a pixel circuit column corresponds to main pixel size Dx, described in the above embodiment, and a pixel circuit row corresponds to sub-pixel size Dy, described in the above embodiment. Further, the main pixel size Dx and the sub-pixel size Dy may be set, for example, at 50 μm.

When M fringe images are used to generate a phase contrast image in a manner similar to the above embodiment, self images G1 of the unit grating members 22a of the first grating 2 are arranged in such a manner that M pixel circuit rows (M is the number of rows) are one image resolution D of the phase contrast image in a sub scan direction. In FIG. 15, self image G1 of the unit grating member 22a illustrated in FIG. 8 is schematically illustrated with straight lines.

Specifically, when the pitch of the second grating 3 and the pitch of the self image G1 of the unit grating members 22a in X direction formed at the position of the second grating 3 are P₂, and the image resolution of the phase contrast image in the sub scan direction is D=Dy×M, the unit grating members 22a are arranged in Y direction in such a manner to be shifted, one by one, by P₂/M, which is a value obtained by dividing pitch P₂ by M, in X direction in a manner similar to the above embodiment.

For example, when M=5, one pixel circuit 70 illustrated in FIG. 16 can detect an image signal corresponding to one unit grating member 22a of the first grating 2. In other words, five pixel circuit rows connected to five gate electrodes 73, illustrated in FIG. 16, detect image signals representing five fringe images that are different from each other, respectively. In FIG. 16, one grating member 32 of the second grating 3 and self image G1 correspond to one pixel circuit column. However, many grating members 32 and self image G1 may be present for one pixel circuit column in actual cases, and FIG. 16 illustrates such cases in a simplified manner.

Therefore, an image signal read out from a pixel circuit row connected to a gate electrode G11 for a first readout line is obtained as first fringe image signal M1, an image signal read out from a pixel circuit row connected to a gate electrode G12 for a second readout line is obtained as second fringe image signal M2, an image signal read out from a pixel circuit row connected to a gate electrode G13 for a third readout line is obtained as third fringe image signal M3, an image signal read out from a pixel circuit row connected to a gate electrode G14 for a fourth readout line is obtained as fourth fringe image signal M4, and an image signal read out from a pixel circuit row connected to a gate electrode G15 for a fifth readout line is obtained as fifth fringe image signal M5.

Further, the method for generating the phase contrast image based on the first through fifth fringe image signals is similar to the above embodiment. When the size of one pixel circuit 70 in the main scan direction and in the sub scan direction is 50 μm as described above, the image resolution of the phase contrast image in the main scan direction is 50 μm, and the image resolution of the phase contrast image in the sub scan direction is 50 μm×5=250 μm.

Further, the directions in which the gate electrode and the data electrode of the radiation image detector extend are not limited to the example illustrated in FIG. 16. For example, the direction in which the gate electrode extends may be the vertical direction on the paper of FIG. 16, and the direction in which the data line extends may be the horizontal direction on the paper of FIG. 16.

Further, the self image G1 of the first grating 2 and the second grating 3 may be rotated by 90° with respect to the arrangement of the radiation image detector illustrated in FIG. 16. In this case, it is possible to obtain image signals constituting fringe images that are different from each other in a manner similar to the above embodiments by obtaining image signals readout from pixel circuits 70 arranged parallel to the gate electrode.

Further, the shape of each pixel of the radiation image detector is not limited to a square. For example, the shape of each pixel may be a rectangle, a parallelogram, or the like. Further, a radiation image detector using a CMOS sensor, in which many pixel circuits 80 are two-dimensionally arranged, as illustrated in FIG. 17, may be used, for example. In the radiation image detector using the CMOS sensor, visible light is generated by irradiation with radiation, and charge signals are detected in the pixel circuit 80 by performing photoelectric conversion on the visible light. The radiation image detector using the CMOS sensor is provided for each pixel circuit row, and includes many gate electrodes 82 and many reset electrodes 84, and many data electrodes 83. The gate electrode 82 outputs a drive signal for driving a signal readout circuit included in the pixel circuit 80. The data electrode 83 is provided for each pixel circuit column, and outputs charge signals read out from the signal readout circuit of each of the pixel circuits 80. Further, a row selection scan unit 85 that outputs a drive signal to the signal readout circuit is connected to the gate electrodes 82 and the reset electrodes 84. Further, a signal processing unit 86 that performs predetermined processing on the charge signals output from each pixel circuit is connected to the data electrodes 83.

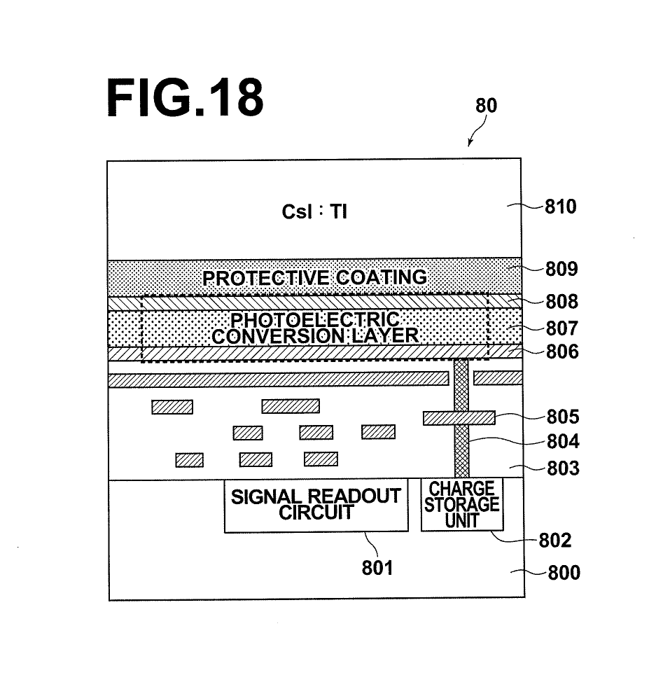

As illustrated in FIG. 18, each pixel circuit 80 includes a lower electrode 806, a photoelectric conversion layer 807, an upper electrode 808, a protective coating 809, and a radiation conversion layer 810. The lower electrode 806 is formed above a substrate 800 with an insulation layer 803 between the substrate 800 and the lower electrode 806. The photoelectric conversion layer 807 is formed on the lower electrode 806, and the upper electrode 808 is formed on the photoelectric conversion layer 807. The protective coating 809 is formed on the upper electrode 808, and the radiation conversion layer 810 is formed on the protective coating 809.

For example, the radiation conversion layer 810 is made of CsI:TI, which generates light with the wavelength of 550 nm by irradiation with radiation. It is desirable that the thickness of the radiation conversion layer 810 is approximately 500 μm.

The upper electrode 808 is made of a transparent conductive material with respect to incident light, because it is necessary to make the light with the wave length of 550 nm enter the photoelectric conversion layer 807. The lower electrode 806 is a thin layer (coating) divided into each pixel circuit 80, and is made of a transparent or opaque conductive material.

The photoelectric conversion layer 807 is made of a photoelectric conversion material that absorbs light, for example, with the wavelength of 550 nm and generates charges based on the light. The photoelectric conversion material is, for example, an organic semiconductor, an organic material containing an organic pigment, a high-absorption-coefficient inorganic semiconductor crystal having a direct-transition-type band gap, and the like alone or in combination.

Further, when a predetermined bias voltage is applied between the upper electrode 808 and the lower electrode 806, charges of one of the polarities of charges generated in the photoelectric conversion layer 807 move to the upper electrode 808, and charges of the other polarity move to the lower electrode 806.

Further, a charge storage unit 802 and a signal readout circuit 801 are formed in a substrate 800 under the lower electrode 806 in such a manner to correspond to the lower electrode 806. The charge storage unit 802 stores charges that have moved to the lower electrode 806, and the signal readout circuit 801 converts the charges stored in the charge storage unit 802 into a voltage signal, and outputs the voltage signal.

The charge storage unit 802 is electrically connected to the lower electrode 806 by a plug 804 made of a conductive material formed through the insulation layer 803. The signal readout circuit 801 is composed of a known CMOS circuit.

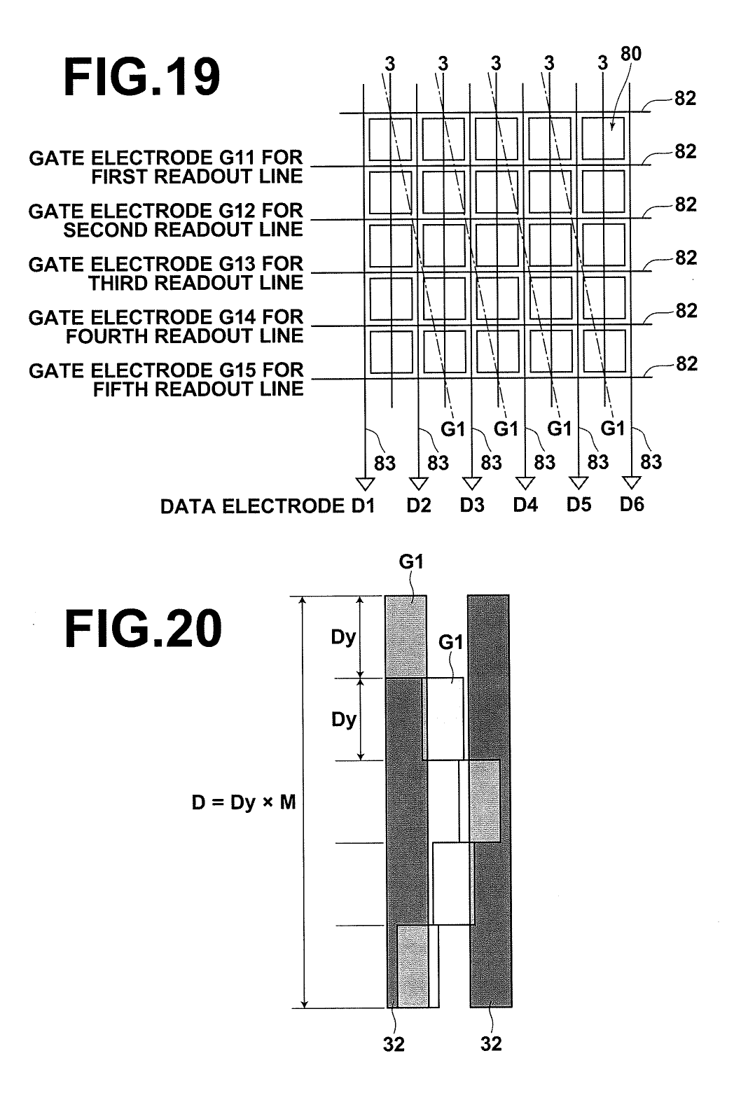

In the radiation image detector using the CMOS sensor as described above, when the second grating 3 and the pixel circuit column (data electrode) are set parallel to each other, as illustrated in FIG. 19, one pixel circuit column corresponds to main pixel size Dx, described in the above embodiment, and one pixel circuit row corresponds to sub-pixel size Dy, described in the above embodiment. In the radiation image detector using the CMOS sensor, main pixel size Dx and sub-pixel size Dy may be, for example, 10 μm.

When M fringe images are used to generate a phase contrast image in a manner similar to the above embodiment, self images G1 of the unit grating members 22a of the first grating 2 are arranged in such a manner that M pixel circuit rows (M is the number of rows) are one image resolution D of the phase contrast image in a sub scan direction. In FIG. 19, self image G1 of the unit grating member 22a illustrated in FIG. 8 is schematically illustrated with straight lines.

Specifically, when the pitch of the second grating 3 and the pitch of the self image G1 of the unit grating members 22a in X direction formed at the position of the second grating 3 are P₂, and the image resolution of the phase contrast image in the sub scan direction is D=Dy×M, the unit grating members 22a are arranged in Y direction in such a manner to be shifted, one by one, by P₂/M, which is a value obtained by dividing pitch P₂ by M, in X direction in a manner similar to the above embodiment.

For example, when M=5, one pixel circuit 80 illustrated in FIG. 19 can detect an image signal corresponding to one unit grating member 22a of the first grating 2. In other words, five pixel circuit rows connected to five gate electrodes 82, illustrated in FIG. 19, detect image signals representing five fringe images that are different from each other, respectively. In FIG. 19, one grating member 32 of the second grating 3 and self image G1 correspond to one pixel circuit column. However, many grating members 32 and self image G1 may be present for one pixel circuit column in actual cases, and FIG. 19 illustrates such cases in a simplified manner.

Therefore, in a manner similar to the radiation image detector using TFT switches, an image signal read out from a pixel circuit row connected to a gate electrode G11 for a first readout line is obtained as first fringe image signal M1, an image signal read out from a pixel circuit row connected to a gate electrode G12 for a second readout line is obtained as second fringe image signal M2, an image signal read out from a pixel circuit row connected to a gate electrode G13 for a third readout line is obtained as third fringe image signal M3, an image signal read out from a pixel circuit row connected to a gate electrode G14 for a fourth readout line is obtained as fourth fringe image signal M4, and an image signal read out from a pixel circuit row connected to a gate electrode G15 for a fifth readout line is obtained as fifth fringe image signal M5.

Further, in a manner similar to the case of the radiation image detector using the TFT switch, the directions in which the gate electrode and the data electrode of the radiation image detector are not limited to the example illustrated in FIG. 19. For example, the direction in which the gate electrode extends may be the vertical direction on the paper of FIG. 19, and the direction in which the data line extends may be the horizontal direction on the paper of FIG. 19.

Further, the self image G1 of the first grating 2 and the second grating 3 may be rotated by 90° with respect to the arrangement of the radiation image detector illustrated in FIG. 19. In this case, it is possible to obtain image signals constituting fringe images that are different from each other in a manner similar to the above embodiments by obtaining image signals read out from pixel circuits 80 arranged parallel to the gate electrode.

Further, the shape of each pixel of the radiation image detector is not limited to a square. For example, the shape of each pixel may be a rectangle, a parallelogram, or the like. Further, the method for generating the phase contrast image based on the first through fifth fringe images is similar to the above embodiment. When the size of one pixel circuit 80 in the main scan direction and in the sub scan direction is 10 μm as described above, the image resolution of the phase contrast image in the main scan direction is 10 μm, and the image resolution of the phase contrast image in the sub scan direction is 10 μm×5=50 μm.

As described above, the radiation image detector using TFT switches or the radiation image detector using the CMOS sensor may be used. However, in these radiation image detectors, the shape of a pixel is a square. Therefore, when the present invention is applied, the resolution in the sub scan direction becomes lower, compared with the resolution in the main scan direction. Meanwhile, in the optical-readout-type radiation image detector, described in the first embodiment and the second embodiment, resolution Dx in the main scan direction is limited by the width of a linear electrode (a direction orthogonal to a direction in which the linear electrode extends). However, in the optical-readout-type radiation image detector, resolution Dy in the sub scan direction is determined by the width of readout light from the linear readout light source 50 in the sub scan direction and the product of a time period of storage for one line by a charge amplifier 200 and the movement speed of the linear readout light source 50. Both of the resolution in the main scan direction and the resolution in the sub scan direction are typically tens of μm, and it is possible to design the radiation image detector in such a manner to increase the resolution in the sub scan direction while the resolution in the main scan direction is maintained. For example, it is possible to design the radiation image detector by reducing the width of the linear readout light source 50, or by lowering the movement speed of the linear readout light source 50. Therefore, the optical-readout-type radiation image detector, described in the first embodiment and the second embodiment, is more advantageous.

Further, since plural fringe images are obtainable by one radiography operation, it is not necessary to use a semiconductor detector that is repeatedly usable immediately after use, as described above. A stimulable phosphor sheet (storage phosphor sheet), a silver halide film, and the like may be used. In such a case, a readout pixel when information is read out from the stimulable phosphor sheet or a developed silver halide film corresponds to the pixel recited in the claims of the present application.

Further, in the above embodiments, the grating member 22 of the first grating 2 is composed of plural unit grating members 22a that are in rectangular shape. Further, the plural unit grating members 22a are arranged in Y direction in such a manner to be shifted, one by one, by a predetermined pitch in X direction. This structure may be adopted in the second grating 3, and the first grating 2 may be formed by a grating member 22 in straight line form in a manner similar to the second grating 3 illustrated in FIG. 5.

In the above embodiment, the unit grating members 22a are arranged in such a manner that a distance between self image G1 of the unit grating members 22a constituting the first grating 2 and the grating member 32 of the second grating 3 gradually increases along Y direction, as illustrated in FIG. 8. However, it is not necessary that the unit grating members 22a are arranged in such a manner. The unit grating members 22a may be arranged in any manner as long as self image G1 of each of the unit grating members 22a is formed at a position away from the grating member 32 of the second grating 3, by (P₂/M)×k(k=0 through M−1), through image resolution D, when the pitch of self image G1 of the unit grating member 22a in X direction formed at the position of the second grating 3 is P₂, and image resolution of the phase contrast image in sub scan direction is D=Dy×M. Specifically, for example, when M=5, the unit grating members 22a may be arranged so that self image G1 is formed as illustrated in FIG. 20. In this case, image signals representing five fringe images are obtainable by obtaining image signals of a group of pixel rows of the first readout line through a group of pixel rows of the fifth readout line, respectively, in a manner similar to the above embodiments.

In the above embodiment, an image that has been conventionally difficult to be rendered can be obtained by obtaining the phase contrast image. However, since conventional X-ray diagnostic imaging is based on absorption images, it is helpful in image reading to refer to an absorption image corresponding a phase contrast image. For example, it is effective to use information represented by a phase contrast image to supplement information that could not be represented by an absorption image. The information represented by the phase contrast image may be used by superimposing or placing the absorption image and the phase contrast image one on the other by using appropriate processing, such as weighting, gray scale (gradation) and frequency processing.

However, if a phase contrast image and an absorption image are obtained in different radiography operations, it is difficult to place the phase contrast image and the absorption image one on the other in an excellent manner because a patient's body may move between the two radiography operations. Further, since the number of times of radiography increases, a burden on the patient increases. Further, in recent years, small-angle scattering images have drawn attention besides the phase contrast image and the absorption image. The small-angle scattering image can represent tissue conditions attributable to a fine structure (ultrastructure) in a tissue to be examined. The small-angle scattering image is a prospective new representation method for image diagnosis, for example, in cancers and circulatory diseases.

Therefore, the image generation unit 5 may generate an absorption image or a small-angle scattering image based on plural fringe images obtained to generate the phase contrast image.

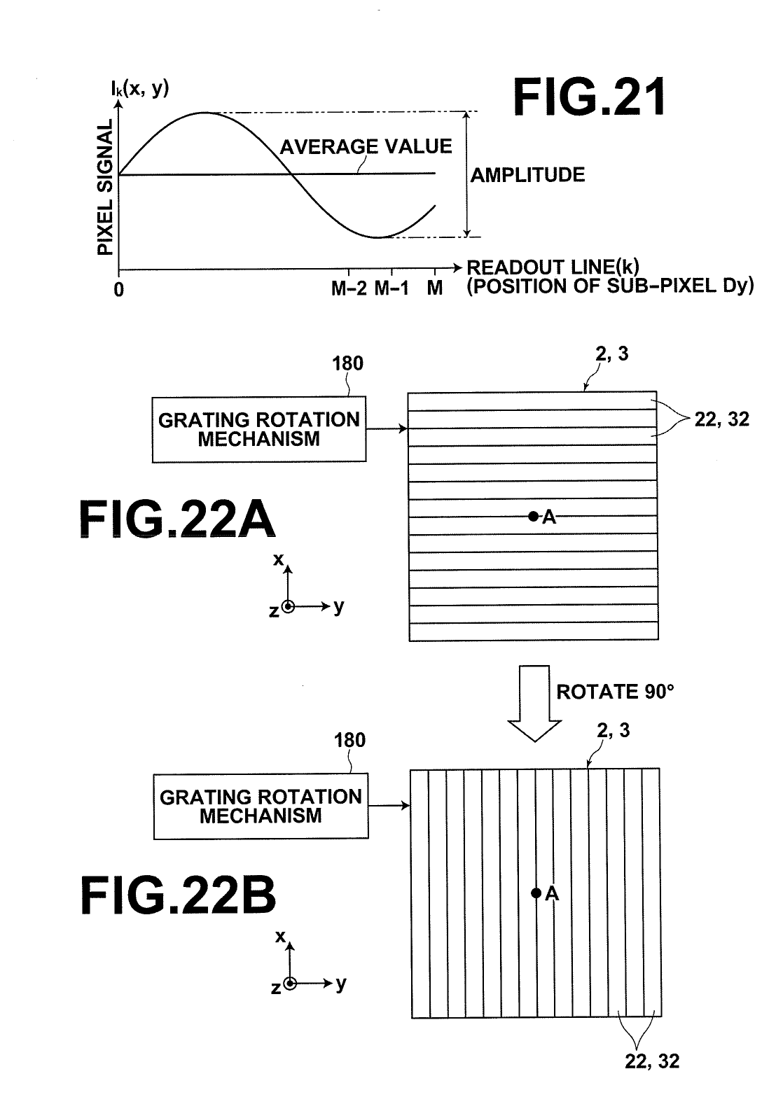

Specifically, an average value is obtained by averaging, with respect to k, pixel signal Ik(x,y) obtainable for each pixel, as illustrated in FIG. 21, and an absorption image can be formed based on the obtained value. Accordingly, an absorption image is generated. Calculation of the average value may be performed by simply averaging pixel signal Ik (x,y) with respect to k. However, when the value of M is small, an error (difference) becomes large. Therefore, after fitting is performed on the pixel signal Ik(x,y) by a sinusoidal wave, an average value of the sinusoidal wave after fitting may be obtained. Further, it is not necessary to use the sinusoidal wave, and a square wave or a triangle wave may be used.

In generation of the absorption image, it is not necessary to use the average value. An addition value obtained by adding pixel signal Ik(x,y) with respect to k, or the like may be used as long as the value corresponds to the average value.

The small-angle scattering image may be generated by calculating an amplitude value of pixel signal Ik(x,y) obtainable for each pixel, and by forming an image based on the obtained value. The amplitude value may be calculated by obtaining a difference between the maximum value and the minimum value of the pixel signal Ik (x,y). However, when the value of M is small, an error (difference) becomes large. Therefore, after fitting is performed on the pixel signal Ik (x,y) by a sinusoidal wave, an amplitude value of the sinusoidal wave after fitting may be obtained. Further, it is not necessary to use the amplitude value to generate the small-angle scattering image, and a variance, a standard deviation or the like may be used as a value corresponding to dispersion with respect to an average value.

Further, a phase contrast image is based on a refraction component of X-rays in a periodic arrangement direction (X direction) of the grating members 22 of the first grating 2 and the grating members 32 of the second grating 3. Therefore, a refraction component of X-rays in a direction (Y direction) in which the grating members 22, 23 extend is not reflected in the phase contrast image. Specifically, the outline of a region along a direction (Y direction if the direction crosses X direction at right angles) crossing X direction is rendered, as a phase contrast image based on the refraction component in X direction, through a grating plane, which is XY plane. Therefore, the outline of the region along X direction, which does not cross X direction, is not rendered as the phase contrast image in X direction. Specifically, some region is not rendered depending on the shape or direction of the region, which is subject to be examined. For example, when the direction of a weight-bearing plane of an articular cartilage, such as a knee, is set to Y direction of XY directions, which are in-plane directions of a grating, rendering of the outline of a region in the vicinity of a weight-bearing plane (YZ plane) substantially along Y direction is supposed to be sufficient. However, rendering of tissues (a tendon, a ligament or the like) in the vicinity of cartilage, and the tissues crossing the weight-bearing plane and extending substantially along X direction, is supposed to be insufficient. If rendering is insufficient, the subject to be examined may be moved, and radiography may be performed again on the region which has been insufficiently rendered. However, if radiography is performed again, a burden on the subject to be examined and the work of the radiographer increase. Further, it is difficult to secure a position regeneration characteristic between the previous image and the image obtained by performing radiography again.

Therefore, as another example, a rotation mechanism 180 may be provided, as illustrated in FIGS. 22A, 22B. An imaginary line (optical axis A of X-rays) that is orthogonal to the grid planes of the first and second gratings 2, 3 and passes the centers of the grid planes may be used as a center of rotation, and the first grating 2 and the second grating 3 may be rotated, by an arbitrary angle, from a first direction illustrated in FIG. 22A to a second direction illustrated in FIG. 22B. Further, a phase contrast image may be generated in each of the first direction and the second direction. Such structure is advantageous. In FIGS. 22A, 22B, the grating members 22 of the first grating 2 are illustrated with straight lines to simplify the drawing. In actual cases, plural unit grating members 22a are arranged in such a manner to be shifted in X direction in a manner similar to the above embodiment.

When the apparatus is structured in such a manner, it is possible to solve the aforementioned problem in the position regeneration characteristic. FIG. 22A illustrates the first direction of the first grating 2 and the second grating 3 in which the grating members 32 of the second grating 3 extend along Y direction. FIG. 22A illustrates the second direction of the first grating 2 and the second grating 3 in which the grating members 32 of the second grating 3 extend along X direction by rotating the first grating 2 and the second grating 3, by 90 degrees, from the state illustrated in FIG. 22A. However, the rotation angle of the first grating 2 and the second grating 3 may be an arbitrary angle as long as the inclination relationship between the first grating 2 and the second grating 3 is maintained. Further, rotation operations may be performed twice or more to change the direction to a third direction, a fourth direction and the like in addition to the first direction and the second direction. Further, a phase contrast image may be generated at each direction.

In the above descriptions, the first grating 2 and the second grating 3, which are one-dimensional gratings, are rotated. Alternatively, the first grating 2 and the second grating 3 may be structured as two-dimensional gratings composed of two-dimensionally-arranged extending members 22, 32, respectively.

When the apparatus is structured in such a manner, it is possible to obtain a phase contrast image for the first direction and the second direction by performing one radiography operation. Therefore, there is no influence of the body movement of the subject between radiography operations and vibration of the apparatus, compared with the structure in which the one-dimensional gratings are rotated. Therefore, a more excellent position regeneration characteristic between the phase contrast image for the first direction and the phase contrast image for the second direction is achievable. Further, since a rotation mechanism is not used, it is possible to simplify the apparatus and to reduce the cost for production.

Further, in the radiation phase image radiographic apparatus in the above embodiment, two gratings, namely, the first grating 2 and the second grating 3 are used. However, it is possible to omit the second grating 3 by providing the function of the second grating 3 in a radiation image detector. Next, the structure of a radiation image detector having the function of the second grating 3 will be described.

In the radiation image detector having the function of the second grating 3, self image G1 of the first grating 2 formed by the first grating 2 by passing radiation through the first grating 2 is detected. Further, charge signals corresponding to the self image G1 are stored in a charge storage layer divided in grid form, which will be described later. Accordingly, the intensity of the self image G1 is modulated, and a fringe image is generated. The generated fringe image is output as an image signal.

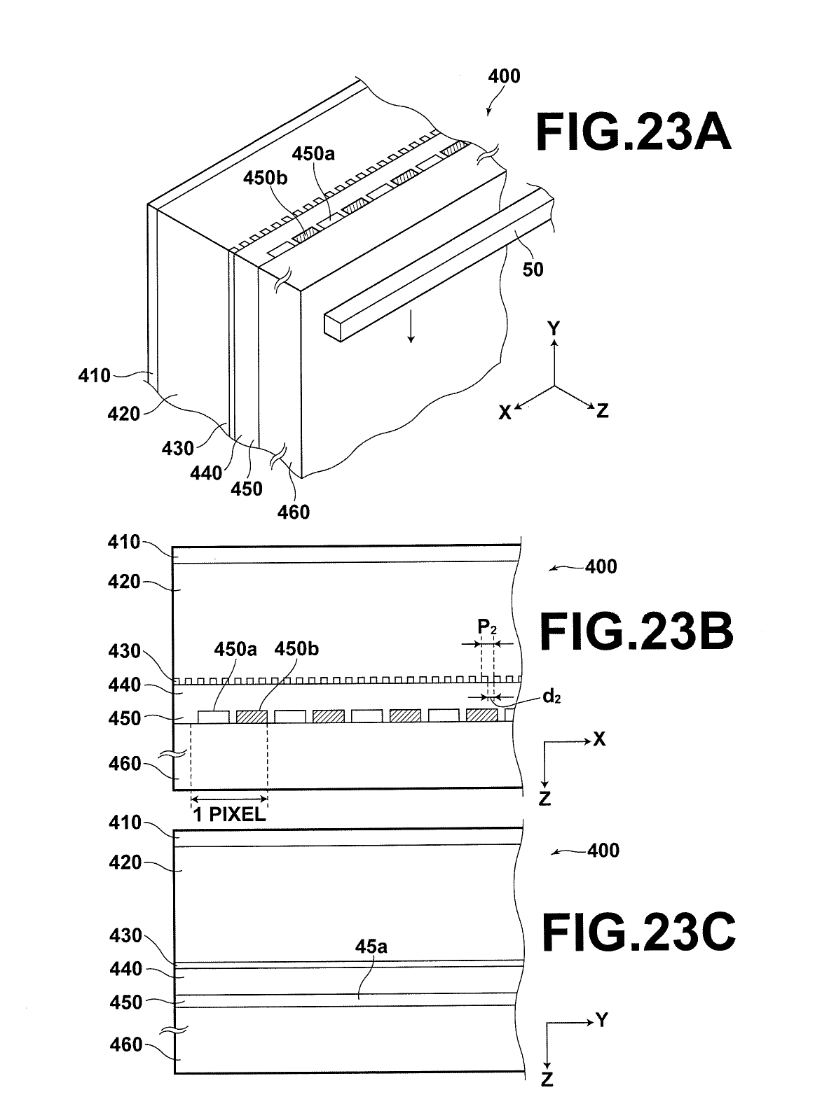

FIG. 23A is a perspective view of a radiation image detector 400 having a function of the second grating 3. FIG. 23B is an XY-plane cross section of the radiation image detector 400 illustrated in FIG. 23A. FIG. 23C is a YZ-plane cross section of the radiation image detector 400 illustrated in FIG. 23A.

As illustrated in FIG. 23A through 23C, the radiation image detector 400 includes a first electrode layer 410, a photoconductive layer 420 for recording, a charge storage layer 430, a photoconductive layer 440 for readout, and a second electrode layer 450, which are deposited one on another in this order. The first electrode layer 410 passes radiation, and the photoconductive layer 420 for recording generates charges by irradiation with radiation that has passed through the first electrode layer 410. The charge storage layer 430 acts as an insulator for charges of one of the polarities of the charges generated in the photoconductive layer 420 for recording, and acts as a conductor for charges of the opposite polarity. Further, the photoconductive layer 440 for readout generates charges by irradiation with readout light. These layers are formed on a glass substrate 460 in the mentioned order with the second electrode layer 450 at the bottom.

Further, in the radiation image detector 400 having the function of the second grating 3, the materials of the first electrode layer 410, the photoconductive layer 420 for recording, the charge storage layer 430, the photoconductive layer 440 for readout and the second electrode layer 450 are similar to those of the first electrode layer 41, the photoconductive layer 42 for recording, the charge storage layer 43, the photoconductive layer 44 for readout, and the second electrode layer 45 in the radiation image detector 4 in the above embodiment.

Further, in the radiation image detector 400 having the function of the second grating 3, the shape of the charge storage layer 430 is different from the charge storage layer 43 in the radiation image detector 4 in the above embodiment. As illustrated in FIGS. 23A through 23C, the charge storage layer 430 is divided in linear form parallel to a direction in which transparent linear electrodes 450a and light-blocking linear electrodes 450b extend in the second electrode layer 450.

The charge storage layer 430 is divided with a pitch narrower than the arrangement pitch of the transparent linear electrodes 450a or the light-blocking linear electrodes 450b. Arrangement pitch P₂ of the charge storage layer 430 is similar to the conditions of the second grating 3 in the above embodiment. However, P₁′ in the formulas (1) and (2) represents the pitch of self image G1 of the first grating 2 at the position of the radiation image detector 400.

Further, the thickness of the charge storage layer 430 is less than or equal to 2 μm in a direction in which the layer is deposited (Z direction).

For example, the charge storage layer 430 may be formed by resistance heating vapor deposition by using the aforementioned materials and a metal mask or a mask formed by fibers or the like. The metal mask is formed by arranging openings in a metal plate. Alternatively, the charge storage layer 430 may be formed by photolithography.

With respect to a distance between the first grating 2 and the radiation image detector 400 for functioning as a Talbot interferometer, conditions are similar to those of the distance between the first grating 2 and the second grating 3, because the radiation image detector 400 functions as the second grating 3. Further, in a manner similar to the second embodiment, the apparatus may be structured in such a manner that the first grating 2 projects radiation that has entered the first grating 2 without diffraction. Further, distance Z₂ between the first grating 2 and the radiation image detector 400 may be set without regard to the Talbot interference distance. The distance may satisfy the formula (18).

Next, the action of the radiation image detector 400 structured as described above will be described.

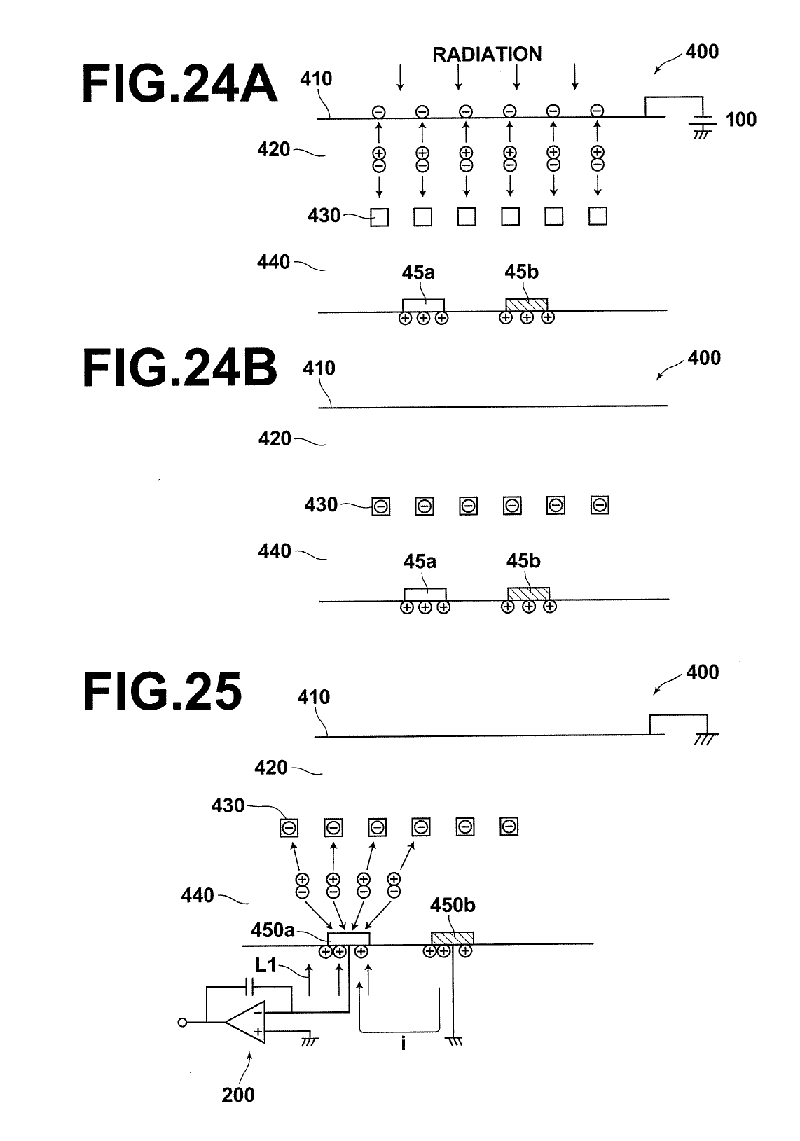

First, as illustrated in FIG. 24A, while negative voltage is applied to the first electrode layer 410 of the radiation image detector 400 by a high voltage source 100, radiation carrying self image G1 of the first grating 2 formed by a Talbot effect irradiates the radiation image detector 400 from the first electrode layer 410 side thereof.

The radiation that has irradiated the radiation image detector 400 passes through the first electrode layer 410, and irradiates the photoconductive layer 420 for recording. An electron-hole pair is generated in the photoconductive layer 420 for recording by irradiation with the radiation. A positive charge of the charge pair is combined with a negative charge in the first electrode layer 410, and disappears. A negative charge of the charge pair is stored in the charge storage layer 430 as a latent image charge (please refer to FIG. 24B).

Here, the charge storage layer 430 is divided in linear form with an arrangement pitch as described above. Therefore, among charges that have been generated based on the self image G1 of the first grating 2 in the photoconductive layer 420 for recording, only charges with the charge storage layer 430 present just under the charges are trapped and stored by the charge storage layer 430. Other charges pass through space between linear patterns of the linear charge storage layer 430, and pass through the photoconductive layer 440 for readout. After the charges pass through the photoconductive layer 440 for readout, the charges flow out to the transparent linear electrodes 450a and the light-blocking linear electrodes 450b.

As described above, among charges generated in the photoconductive layer 420 for recording, only charges with the linear charge storage layer 430 present just under the charges are stored in the charge storage layer 430. Because of this action, the intensity of the self image G1 of the first grating 2 is modulated by overlapping with the linear patterns of the charge storage layer 430. Further, image signals of a fringe image reflecting a distortion of the wavefront of self image G1 by a subject to be examined are stored in the charge storage layer 430. In other words, the charge storage layer 430 achieves a function similar to the second grating 3 in the above embodiment.

Next, as illustrated in FIG. 25, while the first electrode layer 410 is earthed, linear readout light L1 output from the linear readout light source 50 illuminates the radiation image detector 400 from the second electrode layer 450 side. The readout light L1 passes through the transparent linear electrodes 450a, and illuminates the photoconductive layer 440 for readout. Positive charges generated in the photoconductive layer 440 for readout by illumination with the readout light L1 are combined with latent image charges in the charge storage layer 430. Further, negative charges generated in the photoconductive layer 440 for readout by illumination with the readout light L1 are combined with positive charges in the light-blocking linear electrodes 450b through a charge amplifier 200 connected to the transparent linear electrodes 450a.

Since the negative charges generated in the photoconductive layer 440 for readout and the positive charges in the light-blocking linear electrodes 450b are combined with each other, an electric current flows to the charge amplifier 200. The electric current is integrated, and detected as image signals.

Further, the linear readout light source 50 moves in a sub-scan direction (Y direction), and the radiation image detector 400 is scanned with the linear readout light L1. Further, image signals are sequentially detected for each readout line illuminated with the linear readout light L1 by the aforementioned action. The detected image signal for each readout line is sequentially input to the image generation unit 5, and stored.

Further, the entire area of the radiation image detector 400 is scanned with readout light L1, and image signals for a whole one frame are stored in the image generation unit 5. The image generation unit 5 obtains, based on the stored image signals, image signals representing five fringe images different from each other in a manner similar to the above embodiment. Further, the image generation unit generates a phase contrast image based on the image signals representing the five fringe images.

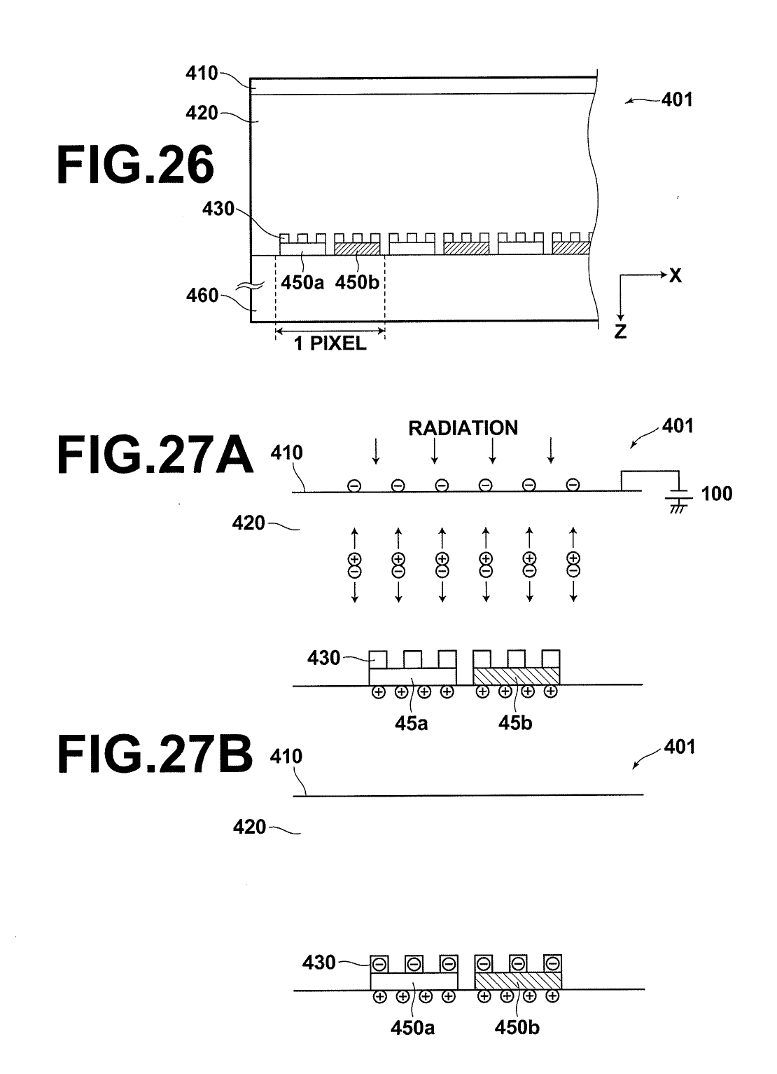

In the radiation image detector 400 that has a function of the second grating 3 as described above, three layers of the photoconductive layer 420 for recording, the charge storage layer 430 and the photoconductive layer 440 for readout are provided between the electrodes. However, it is not necessary that the layers are structured in such a manner. For example, as illustrated in FIG. 26, the linear charge storage layer 430 may be provided directly on the transparent linear electrodes 450a and the light-blocking linear electrodes 450b of the second electrode layer without providing the photoconductive layer 440 for readout. Further, the photoconductive layer 420 for recording may be provided on the charge storage layer 430. The photoconductive layer 420 for recording functions also as a photoconductive layer for readout.

In this radiation image detector 401, the charge storage layer 430 is provided directly on the second electrode layer 450 without providing the photoconductive layer 440 for readout. Therefore, it is possible to form the linear charge storage layer 430 by vapor deposition. Hence, it is possible to easily form the linear charge storage layer 430. In the vapor deposition process, a metal mask or the like is used to selectively form a linear pattern. When the radiation image detector is structured in such a manner to provide the linear charge storage layer 430 on the photoconductive layer 440 for readout, a metal mask for forming the linear charge storage layer 430 by vapor deposition needs to be set after vapor deposition of the photoconductive layer 440 for readout. Therefore, an operation in air between the vapor deposition process of the photoconductive layer 440 for readout and the vapor deposition process of the photoconductive layer 420 for recording may make the photoconductive layer 440 for readout deteriorate. Further, there is a risk of lowering the quality of the radiation image detector by mixture of a foreign substance between the photoconductive layers. However, when the photoconductive layer 440 for readout is not provided, as described above, it is possible to reduce the operation in air after vapor deposition of the photoconductive layer. Hence, it is possible to reduce the risk of deterioration in the quality, as described above.

The material of the photoconductive layer 420 for recording and the material of the charge storage layer 430 are similar to those in the aforementioned radiation image detector 400. Further, the linear structure of the charge storage layer 430 is similar to the aforementioned radiation image detector.

Next, the actions of recording and readout of a radiographic image by the radiation image detector 401 will be described.

First, as illustrated in FIG. 27A, negative voltage is applied to the first electrode layer 410 of the radiation image detector 401 by a high voltage source 100. While the negative voltage is applied, radiation carrying self image G1 of the first grating 2 irradiates the radiation image detector 401 from the first electrode layer 410 side.

Further, radiation that has irradiated the radiation image detector 401 passes through the first electrode layer 410, and irradiates the photoconductive layer 420 for recording. An electron-hole pair is generated in the photoconductive layer 420 for recording by irradiation with the radiation. A positive charge of the charge pair is combined with a negative charge in the first electrode layer 410, and disappears. A negative charge of the charge pair is stored in the charge storage layer 430 as a latent image charge (please refer to FIG. 27B). Since the linear charge storage layer 430 in contact with the second electrode layer 450 is an insulating layer, charges that have reached the charge storage layer 430 are trapped there. The charges are stored and remain there, and do not reach the second electrode layer 450.

Here, in a manner similar to the radiation image detector 400 as described above, among charges generated in the photoconductive layer 420 for recording, only charges with the linear charge storage layer 430 present just under the charges are stored in the charge storage layer 430. Because of this action, the intensity of the self image G1 of the first grating 2 is modulated by overlapping with the linear pattern of the charge storage layer 430. Further, image signals of a fringe image reflecting a distortion of the wavefront of self image G1 by a subject to be examined are stored in the charge storage layer 430.

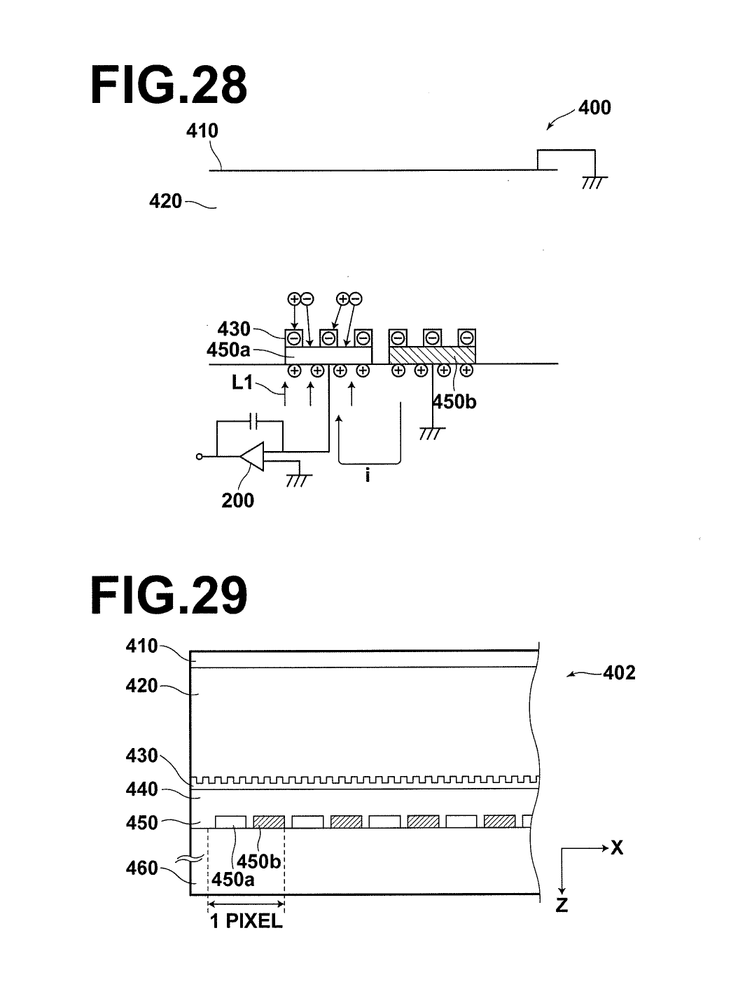

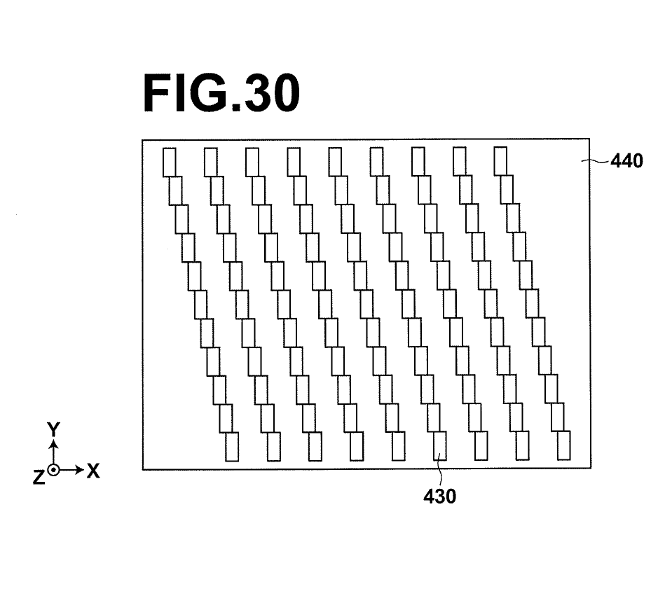

Further, as illustrated in FIG. 28, while the first electrode layer 410 is earthed, linear readout light L1 output from the linear readout light source 50 illuminates the radiation image detector 400 from the second electrode layer 450 side. The readout light L1 passes through the transparent linear electrodes 450a, and illuminates the photoconductive layer 420 for recording in the vicinity of the charge storage layer 430. Positive charges generated by illumination with the readout light L1 are attracted by the linear charge storage layer 430, and recombined with negative charges. Further, negative charges generated by illumination with the readout light L1 are attracted by the transparent linear electrodes 450a, and combined with positive charges in the transparent linear electrodes 450a, and positive charges in the light-blocking linear electrodes 450b through the charge amplifier 200 connected to the transparent linear electrodes 450a. Accordingly, an electric current flows to the charge amplifier 200. The electric current is integrated, and detected as image signals.

In the aforementioned radiation image detectors 400 and 401, the charge storage layer 430 is completely separated in linear form. However, it is not necessary that the charge storage layer 430 is formed in such a manner. For example, as in a radiation image detector 402 illustrated in FIG. 29, a linear pattern may be formed on a flat plate shape to form a grid-shaped charge storage layer 430.

In radiation image detectors 400 through 402, as described above, the charge storage layer 430 is formed in linear (straight-line) grid form in a manner similar to the second grating 3 in the above embodiment. However, it is not necessary that the charge storage layer 430 is formed in such a manner. The structure of the first grating 2 in the above embodiment may be adopted in the charge storage layer 430. Specifically, as illustrated in FIG. 28, the charge storage layer 430 may be formed by arranging plural unit grating patterns in Y direction in such a manner to be shifted, one by one, by a predetermined pitch in X direction. In FIG. 28, patterns only in a part of the charge storage layer 430 are illustrated. In actual cases, the patterns illustrated in FIG. 28 are arranged repeatedly in X direction and in Y direction. Various methods are adoptable as the method for arranging the unit gratings of the first grating 2 in the first embodiment: Similarly, various patterns are adoptable as the pattern of the charge storage layer 430. When the charge storage layer 430 is structured in such a manner, the first grating 2 may be formed by linear (straight-line) grating members 22 similar to the second grating 3 illustrated in FIG. 5.

The radiographic apparatus according to the above embodiments may be applied to a mammography and display system, which obtains a radiographic image of a breast. Further, the radiographic apparatus of the present invention may be applied to a radiographic system for performing radiography on a subject (patient) in standing position, a radiographic system for performing radiography on a subject in decubitus position, a radiographic system that can perform radiography on a subject both in standing position and in decubitus position, a radiographic system for performing so-called long-size radiography, and the like.

Further, the radiographic apparatus of the above embodiments may be applied to a radiation phase CT (computed tomography) apparatus for obtaining a three-dimensional image, a stereoradigraphy apparatus for obtaining a stereo image that can provide stereoscopic view, a tomosynthesis apparatus for obtaining a tomographic image and the like.

What is claimed is:

1. A radiographic apparatus comprising:
a first grating in which a grating structure is periodically arranged, and that forms a first periodic pattern image by passing radiation output from a radiation source;
a second grating in which a grating structure is periodically arranged, and that forms a second periodic pattern image by receiving the first periodic pattern image; and
a radiation image detector in which pixels that detect the second periodic pattern image formed by the second grating are two-dimensionally arranged, and pixel rows of which are sequentially scanned with respect to the direction of pixel columns orthogonal to the pixel rows so as to sequentially read out image signals corresponding to the second periodic pattern image for each of the pixel rows,
wherein one of the first grating and the second grating is composed of a plurality of unit gratings, each corresponding to each pixel arranged in the direction of pixel columns, and which are arranged in the direction of pixel columns, and
wherein the plurality of unit gratings are arranged in such a manner to be shifted, parallel to each other, in a direction orthogonal to a direction in which the other one of the first grating and the second grating extends by distances different from each other with respect to the other one of the first grating and the second grating, and
the apparatus further comprising:
an image generation unit that obtains, based on the image signals obtained by the radiation image detector, image signals read out from groups of the pixel rows, the groups being different from each other, as image signals representing a plurality of fringe images different from each other, and that generates a radiographic image based on the obtained image signals representing the plurality of fringe images.

2. A radiographic apparatus, as defined in claim 1, wherein the unit grating is rectangular.

3. A radiographic apparatus, as defined in claim 1, wherein the unit gratings adjacent to each other form a level difference therebetween.

4. A radiographic apparatus, as defined in claim 1, wherein the second grating is arranged at a position away from the first grating by a Talbot interference distance, and modulates the intensity of the first periodic pattern image formed by a Talbot interference effect of the first grating.

5. A radiographic apparatus, as defined in claim 1, wherein the first grating is an absorption-type grating that forms the first periodic pattern image by passing the radiation as a projection image, and
wherein the second grating modulates the intensity of the first periodic pattern image as the projection image that has passed through the first grating.

6. A radiographic apparatus, as defined in claim 5, wherein the second grating is arranged at a distance shorter than a minimum Talbot interference distance from the first grating.

7. A radiographic apparatus, as defined in claim 1, wherein images of the plurality of unit gratings are arranged in such a manner to be shifted parallel to each other, one by one, by P/M with respect to the other one of the first grating and the second grating, where P is a pitch of the other one of the first grating and the second grating, and M is the number of the fringe images.

8. A radiographic apparatus comprising:
a grating in which a grating structure is periodically arranged, and that forms a periodic pattern image by passing radiation output from a radiation source; and
a radiation image detector including a first electrode layer that passes the periodic pattern image formed by the grating, a photoconductive layer that generates charges by irradiation with the periodic pattern image that has passed through the first electrode layer, a charge storage layer that stores the charges generated in the photoconductive layer, and a second electrode layer in which a multiplicity of linear electrodes that pass readout light are arranged, which are deposited one on another in this order, and from which an image signal for each pixel corresponding to each of the linear electrodes is readout by being scanned with the readout light, and
wherein a plurality of unit grating patterns, each corresponding to each pixel arranged in a direction in which the linear electrodes extend, are arranged in the direction in which the linear electrodes extend in the charge storage layer, and
wherein the plurality of unit grating patterns are arranged in such a manner to be shifted, parallel to each other, in a direction orthogonal to a direction in which the grating extends by distances different from each other with respect to the grating, and
the apparatus further comprising:
an image generation unit that regards, as a direction of pixel rows, a direction in which the linear electrodes are arranged, and regards, as a direction of pixel columns, a direction in which the linear electrodes extend, and obtains, based on image signals obtained by the radiation image detector, image signals read out from groups of the pixel rows, the groups being different from each other, as image signals representing a plurality of fringe images different from each other, and that generates a radiographic image based on the obtained image signals representing the plurality of fringe images.

9. A radiographic apparatus, as defined in claim 8, wherein the unit grating pattern is rectangular.

10. A radiographic apparatus, as defined in claim 8, wherein the unit grating patterns adjacent to each other form a level difference therebetween.

11. A radiographic apparatus, as defined in claim 8, wherein the plurality of unit grating patterns are arranged in such a manner to be shifted parallel to each other, one by one, by P/M with respect to an image of the grating, where P is a pitch of the image of the grating, and M is the number of the fringe images.

12. A radiographic apparatus comprising:
a grating in which a grating structure is periodically arranged; and that forms a periodic pattern image by passing radiation output from a radiation source; and
a radiation image detector including a first electrode layer that passes the periodic pattern image formed by the grating, a photoconductive layer that generates charges by irradiation with the periodic pattern image that has passed through the first electrode layer, a charge storage layer that stores the charges generated in the photoconductive layer, and a second electrode layer in which a multiplicity of linear electrodes that pass readout light are arranged, which are deposited one on another in this order, and from which an image signal for each pixel corresponding to each of the linear electrodes is read out by being scanned with the readout light, and
wherein the charge storage layer is grid-shaped at a pitch narrower than an arrangement pitch of the linear electrodes, and
wherein a plurality of unit gratings, each corresponding to each pixel arranged in a direction in which the linear electrodes extend, are arranged in the direction in which the linear electrodes extend, and
wherein the plurality of unit gratings are arranged in such a manner to be shifted, parallel to each other, in a direction orthogonal to a direction in which the charge storage layer extends by distances different from each other with respect to a grating pattern of the charge storage layer, and
the apparatus further comprising:
an image generation unit that regards, as a direction of pixel rows, a direction in which the linear electrodes are arranged, and regards, as a direction of pixel columns, a direction in which the linear electrodes extend, and obtains, based on image signals obtained by the radiation image detector, image signals read out from groups of the pixel rows, the groups being different from each other, as image signals representing a plurality of fringe images different from each other, and that generates a radiographic image based on the obtained image signals representing the plurality of fringe images.

13. A radiographic apparatus, as defined in claim 12, wherein the unit grating is rectangular.

14. A radiographic apparatus, as defined in claim 12, wherein the unit gratings adjacent to each other form a level difference therebetween.

15. A radiographic apparatus, as defined in claim 12, wherein images of the plurality of unit gratings are arranged in such a manner to be shifted parallel to each other, one by one, by P/M with respect to the grating pattern of the charge storage layer, where P is a pitch of the grating pattern of the charge storage layer, and M is the number of the fringe images.

16. A radiographic apparatus, as defined in claim 8, wherein the grating is a phase-modulation-type grating that modulates phase by 90° or an amplitude-modulation-type grating, and
wherein pitch P₁′ of the periodic pattern image at the position of the radiation image detector, and arrangement pitch P₂ of a grating structure in the charge storage layer satisfy the following formula:
$${P}_{2} = {P}_{1}^{′} = \frac{{Z}_{1} + {Z}_{2}}{{Z}_{1}} {P}_{1} ,$$
where P₁ is a grating pitch of the grating, and Z₁ is a distance from a focal point of the radiation source to the grating, and Z₂ is a distance from the grating to a detection surface of the radiation image detector.

17. A radiographic apparatus, as defined in claim 12, wherein the grating is a phase-modulation-type grating that modulates phase by 90° or an amplitude-modulation-type grating, and
wherein pitch P₁′ of the periodic pattern image at the position of the radiation image detector, and arrangement pitch P₂ of a grating structure in the charge storage layer satisfy the following formula:
$${P}_{2} = {P}_{1}^{′} = \frac{{Z}_{1} + {Z}_{2}}{{Z}_{1}} {P}_{1} ,$$
where P₁ is a grating pitch of the grating, and Z₁ is a distance from a focal point of the radiation source to the grating, and Z₂ is a distance from the grating to a detection surface of the radiation image detector.

18. A radiographic apparatus, as defined in claim 8, wherein the grating is a phase-modulation-type grating that modulates phase by 180°, and
wherein pitch P₁′ of the periodic pattern image at the position of the radiation image detector, and arrangement pitch P₂ of a grating structure in the charge storage layer satisfy the following formula:
$${P}_{2} = {P}_{1}^{′} = \frac{{Z}_{1} + {Z}_{2}}{{Z}_{1}} \cdot \frac{{P}_{1}}{2} ,$$
where P₁ is a grating pitch of the grating, and Z₁ is a distance from a focal point of the radiation source to the grating, and Z₂ is a distance from the grating to a detection surface of the radiation image detector.

19. A radiographic apparatus, as defined in claim 12, wherein the grating is a phase-modulation-type grating that modulates phase by 180°, and
wherein pitch P₁′ of the periodic pattern image at the position of the radiation image detector, and arrangement pitch P₂ of a grating structure in the charge storage layer satisfy the following formula:
$${P}_{2} = {P}_{1}^{′} = \frac{{Z}_{1} + {Z}_{2}}{{Z}_{1 }} \cdot \frac{{P}_{1}}{2} ,$$
where P₁ is a grating pitch of the grating, and Z₁ is a distance from a focal point of the radiation source to the grating, and Z₂ is a distance from the grating to a detection surface of the radiation image detector.

20. A radiographic apparatus, as defined in claim 8, the apparatus further comprising:
a multi-slit composed of an absorption-type grating in which a plurality of radiation blocking members that block the radiation extend at a predetermined pitch, and which is arranged between the radiation source and the grating to selectively block an area of the radiation output from the radiation source,
wherein predetermined pitch P₃ of the multi-slit satisfies the following formula:
$${P}_{3} = \frac{{Z}_{3}}{{Z}_{2}} {P}_{1}^{′} ,$$
where Z₃ is a distance from the multi-slit to the grating, and Z₂ is a distance from the grating to a detection surface of the radiation image detector, and P₂ is an arrangement pitch of a grating structure in the charge storage layer, and P₁′ is a pitch of the periodic pattern image at the position of the radiation image detector.

21. A radiographic apparatus, as defined in claim 12, the apparatus further comprising:
a multi-slit composed of an absorption-type grating in which a plurality of radiation blocking members that block the radiation extend, at a predetermined pitch, and which is arranged between the radiation source and the grating to selectively block an area of the radiation output from the radiation source,
wherein predetermined pitch P₃ of the multi-slit satisfies the following formula:
$${P}_{3} = \frac{{Z}_{3}}{{Z}_{2}} {P}_{1}^{′} ,$$
where Z₃ is a distance from the multi-slit to the grating, and Z₂ is a distance from the grating to a detection surface of the radiation image detector, and P₂ is an arrangement pitch of a grating structure in the charge storage layer, and P₁′ is a pitch of the periodic pattern image at the position of the radiation image detector.

22. A radiographic apparatus, as defined in claim 8, wherein the thickness of the charge storage layer in a direction in which the first electrode layer, the photoconductive layer, the charge storage layer and the second electrode layer are deposited one on another is less than or equal to 2 μm.

23. A radiographic apparatus, as defined in claim 12, wherein the thickness of the charge storage layer in a direction in which the first electrode layer, the photoconductive layer, the charge storage layer and the second electrode layer are deposited one on another is less than or equal to 2 μm.

24. A radiographic apparatus, as defined in claim 8, wherein the dielectric constant of the charge storage layer is less than or equal to twice and greater than or equal to ½ of the dielectric constant of the photoconductive layer.

25. A radiographic apparatus, as defined in claim 12, wherein the dielectric constant of the charge storage layer is less than or equal to twice and greater than or equal to ½ of the dielectric constant of the photoconductive layer.

26. A radiographic apparatus, as defined in claim 8, wherein the radiation image detector is arranged at a position away from the grating by a Talbot interference distance, and modulates the intensity of the periodic pattern image formed by a Talbot interference effect of the grating.

27. A radiographic apparatus, as defined in claim 12, wherein the radiation image detector is arranged at a position away from the grating by a Talbot interference distance, and modulates the intensity of the periodic pattern image formed by a Talbot interference effect of the grating.

28. A radiographic apparatus, as defined in claim 8, wherein the grating is an absorption-type grating that forms the periodic pattern image by passing the radiation as a projection image, and
wherein the radiation image detector modulates the intensity of the periodic pattern image as the projection image that has passed through the grating.

29. A radiographic apparatus, as defined in claim 12, wherein the grating is an absorption-type grating that forms the periodic pattern image by passing the radiation as a projection image, and
wherein the radiation image detector modulates the intensity of the periodic pattern image as the projection image that has passed through the grating.

30. A radiographic apparatus, as defined in claim 28, wherein the radiation image detector is arranged at a distance shorter than a minimum Talbot interference distance from the grating.

31. A radiographic apparatus, as defined in claim 29, wherein the radiation image detector is arranged at a distance shorter than a minimum Talbot interference distance from the grating.

32. A radiographic apparatus, as defined in claim 1, the apparatus further comprising:
a linear readout light source that extends in a direction in which the pixel rows extend,
wherein the radiation image detector is scanned by the linear readout light source in a direction in which the pixel columns extend so as to read out the image signals.

33. A radiographic apparatus, as defined in claim 8, the apparatus further comprising:
a linear readout light source that extends in a direction in which the pixel rows extend,
wherein the radiation image detector is scanned by the linear readout light source in a direction in which the pixel columns extend so as to read out the image signals.

34. A radiographic apparatus, as defined in claim 12, the apparatus further comprising:
a linear readout light source that extends in a direction in which the pixel rows extend,
wherein the radiation image detector is scanned by the linear readout light source in a direction in which the pixel columns extend so as to read out the image signals.

35. A radiographic apparatus, as defined in claim 1, wherein the image generation unit obtains, as image signals representing fringe images different from each other, image signals read out from the pixel rows next to each other.

36. A radiographic apparatus, as defined in claim 8, wherein the image generation unit obtains, as image signals representing fringe images different from each other, image signals read out from the pixel rows next to each other.

37. A radiographic apparatus, as defined in claim 12, wherein the image generation unit obtains, as image signals representing fringe images different from each other, image signals read out from the pixel rows next to each other.

38. A radiographic apparatus, as defined in claim 1, wherein the image generation unit obtains, as image signals representing a fringe image, image signals read out from a group of pixel rows arranged at an interval of at least two pixels therebetween, and obtains, as image signals representing fringe images different from each other, image signals read out from groups of the pixel rows, the groups being different from each other.

39. A radiographic apparatus, as defined in claim 8, wherein the image generation unit obtains, as image signals representing a fringe image, image signals read out from a group of pixel rows arranged at an interval of at least two pixels therebetween, and obtains, as image signals representing fringe images different from each other, image, signals read out from groups of the pixel rows, the groups being different from each other.

40. A radiographic apparatus, as defined in claim 12, wherein the image generation unit obtains, as image signals representing a fringe image, image signals read out from a group of pixel rows arranged at an interval of at least two pixels therebetween, and obtains, as image signals representing fringe images different from each other, image signals read out from groups of the pixel rows, the groups being different from each other.

41. A radiographic apparatus, as defined in claim 1, wherein the image generation unit generates, based on the image signals representing the plurality of fringe images, at least one of a phase contrast image, a small-angle scattering image, and an absorption image.

42. A radiographic apparatus, as defined in claim 8, wherein the image generation unit generates, based on the image signals representing the plurality of fringe images, at least one of a phase contrast image, a small-angle scattering image, and an absorption image.

43. A radiographic apparatus, as defined in claim 12, wherein the image generation unit generates, based on the image signals representing the plurality of fringe images, at least one of a phase contrast image, a small-angle scattering image, and an absorption image.

44. A radiation image detector comprising:
a first electrode layer that passes radiation;
a photoconductive layer that generates charges by irradiation with the radiation that has passed through the first electrode layer;
a charge storage layer that stores the charges generated in the photoconductive layer; and
a second electrode layer in which a multiplicity of linear electrodes that pass readout light are arranged, which are deposited one on another in this order, and from which an image signal for each pixel corresponding to each of the linear electrodes is read out by being scanned with the readout light,
wherein a plurality of unit grating patterns, each corresponding to each pixel arranged in a direction in which the linear electrodes extend, are arranged in the direction in which the linear electrodes extend in the charge storage layer, and
wherein the plurality of unit grating patterns are arranged in such a manner to be shifted, parallel to each other, in a direction orthogonal to the direction in which the linear electrodes extend by distances different from each other with respect to the linear electrodes.
